(19) United States
(12) Patent Application Publication
(10) Pub. No.: US 2011/0272043 A1
(43) Pub. Date: Nov. 10, 2011

(54) CONDENSATE REMOVAL SYSTEM AND METHOD

(75) Inventors: James Hollingsworth, Oklahoma City, OK (US); Ryan A. Johnson, Oklahoma City, OK (US); Steve Hampton, Mustang, OK (US)

(73) Assignee: LITTLE GIANT PUMP COMPANY LLC, Oklahoma City, OK (US)

(21) Appl. No.: 13/087,832

(22) Filed: Apr. 15, 2011

Related U.S. Application Data
(60) Provisional application No. 61/324,541, filed on Apr. 15, 2010.

(51) Int. Cl. F15D 1/00; F16L 3/00; B23P 19/00

(52) U.S. Cl. 137/386; 29/428; 138/106

(57) ABSTRACT

In an embodiment of the present disclosure, an apparatus for handling a fluid is provided. The apparatus comprising a reservoir having a basin which receives the fluid and at least a first port through which the fluid is evacuated; a pump housing including a fluid pump; a fluid conduit in fluid communication with the fluid in the reservoir through the first port of the reservoir and in fluid communication with the fluid pump; at least one sensor which provides an indication of a height of the fluid in the reservoir; and a conduit with a first aperture and a second aperture therethrough, wherein the reservoir and the pump housing are external to the conduit.

### CROSS-REFERENCE TO RELATED APPLICATIONS

This application claims priority to U.S. Provisional Patent Application No. 61/324,541, filed Apr. 15, 2010, titled CONDENSATE REMOVAL SYSTEM AND METHOD, docket FEC0149, the disclosure of which is expressly incorporated herein by reference.

### FIELD OF THE DISCLOSURE

The present disclosure relates to an air handling system. More particularly, the present disclosure relates to a condensation collection and removal apparatus for condensate removal.

### BACKGROUND OF THE DISCLOSURE

An air conditioning or air handling system may include a coolant flowing between heat exchangers. A heat exchanger inside a structure may receive, for example, coolant in a liquid form. The coolant flowing through the heat exchanger in the structure may warm and turn into a gas after flowing through the heat exchanger inside the structure, and a fan may move air over the cooled heat exchanger in the structure, cooling the air. Moisture in the warm air in the structure may condense on the cooled heat exchanger, and the air conditioning system may collect the condensate. Condensate may collect in a reservoir and may be removed from the reservoir with, for example, a pump.

### SUMMARY

In an embodiment of the present disclosure, an apparatus for handling a fluid is provided. The apparatus comprising a reservoir having a basin which receives the fluid and at least a first port through which the fluid is evacuated; a pump housing including a fluid pump; a fluid conduit in fluid communication with the fluid in the reservoir through the first port of the reservoir and in fluid communication with the fluid pump; at least one sensor which provides an indication of a height of the fluid in the reservoir; a controller which activates the fluid pump based on the height of the fluid in the reservoir; and a conduit with a first aperture and a second aperture therethrough, wherein the reservoir and the pump housing are external to the conduit, and the fluid travels from an interior of the conduit, through the first aperture to an exterior of the conduit, into the reservoir, through the fluid conduit, and through the second aperture back into the interior of the conduit.

In another embodiment of the present disclosure, an apparatus for handling a fluid is provided. The apparatus comprising a reservoir having a basin which receives the fluid and at least a first port through which the fluid is evacuated, the reservoir including at least one reservoir bracket to releasably attach the reservoir to a wall; a pump housing including a fluid pump; a fluid conduit in fluid communication with the fluid in the reservoir through the first port of the reservoir and in fluid communication with the fluid pump; at least one sensor which provides an indication of a height of the fluid in the reservoir; a controller which activates the fluid pump based on the height of the fluid in the reservoir; and a wall bracket to releasably attach the reservoir to the wall, the wall bracket including a grommet with an engagement surface, wherein the reservoir bracket and the grommet cooperate to releasably secure the reservoir and to maintain a position of the reservoir relative to the wall.

In yet another embodiment of the present disclosure, a method of installing a condensate removal system for an air handling system is provided. The method comprising the steps of coupling a conduit to a wall, the conduit carrying the coolant lines for the air handling system; coupling a condensate reservoir to the wall independent of the conduit, the condensate reservoir being external to the conduit; and coupling a condensate pump to the wall independent of the condensate reservoir and independent of the conduit, the condensate pump being external to the conduit.

In yet another embodiment of the present disclosure, a conduit for an air handling system having cooling lines and a condensate line is provided. The conduit comprising a base; a first upstanding wall; a second upstanding wall; a first opening through which the cooling lines and the condensate line pass, the first opening being between the first upstanding wall and the second upstanding wall; a second opening through which the cooling lines and the condensate line pass, the second opening being between the first upstanding wall and the second upstanding wall and being spaced apart from the first opening; and a detachable mounting template coupled to one of the base, the first upstanding wall, and the second upstanding wall, the mounting template providing mount locations for at least one of a reservoir and a pump, the mount locations being external to a space between the first upstanding wall and the second upstanding wall.

In yet another embodiment of the present disclosure, an apparatus for handling a fluid is provided. The apparatus comprising a reservoir having a basin which receives the fluid and at least a first port through which the fluid is evacuated; a pump housing including a fluid pump; a fluid conduit in fluid communication with the fluid in the reservoir through the first port of the reservoir and in fluid communication with the fluid pump; at least one sensor which provides an indication of a height of the fluid in the reservoir; a controller which activates the fluid pump based on the height of the fluid in the reservoir; and a float including at least one magnet, the reservoir including a float support which carries the at least one sensor, the at least one sensor providing an indication of a position of the float in the reservoir, the float including a metallic ring structure which directs the magnetic field of the at least one magnet.

In yet another embodiment of the present disclosure, an apparatus for handling a fluid is provided. The apparatus comprising a reservoir having a basin which receives the fluid and at least a first port through which the fluid is evacuated; a pump housing including a fluid pump, the pump housing being releasably coupled to the reservoir; a fluid conduit in fluid communication with the fluid in the reservoir through the first port of the reservoir and in fluid communication with the fluid pump; at least one sensor which provides an indication of a height of the fluid in the reservoir; and a controller which activates the fluid pump based on the height of the fluid in the reservoir.

In yet another embodiment of the present disclosure, an air handling system positioned within a structure is provided. The air handling system comprising a fan and heat exchanger unit; a reservoir positioned to receive a condensate fluid from the fan and heat exchanger unit; a fluid pump in fluid communication with the reservoir to remove the condensate fluid from the reservoir; and a fluid conduit for communicating the fluid removed from the reservoir towards a location outside of the structure, wherein the reservoir and the fluid pump are releasably coupled.

In yet another embodiment of the present disclosure, a method is provided. The method comprising providing a reservoir having a basin which receives the fluid, at least a first port through which the fluid is evacuated, and a sensor provided to monitor a fluid level in the basin; providing a pump unit including a pump housing including a fluid pump; providing a plurality of fluid conduits, each of the fluid conduits being adapted to couple the first port of the reservoir to the pump unit; providing a plurality of wiring harnesses, each of the wiring harnesses being adapted to couple the reservoir and the pump unit; mounting one of the reservoir and the pump unit in a fixed relationship relative to the other of the pump unit and the reservoir within a ductwork; coupling the basin of the reservoir in fluid communication with the fluid pump with a first fluid conduit, the first fluid conduit being selected from the plurality of fluid conduits; and electrically coupling the sensor of the reservoir and the fluid pump to a controller carried by at least one of the reservoir and the pump housing with at least a first wiring harness selected from the plurality of wiring harnesses, the controller configured to activate the fluid pump based on the fluid level in the basin of the reservoir monitored by the sensor.

### BRIEF DESCRIPTION OF THE DRAWINGS

The detailed description of the drawings particularly refers to the accompanying figures in which:

FIG. 1A is a component view of an exemplary air handling system of the present disclosure;

FIG. 1B is a component view of an exemplary reservoir and exemplary condensate pump, showing an exemplary orientation of the reservoir and condensate pump;

FIG. 1C is a component view of an exemplary reservoir and exemplary condensate pump, showing an additional exemplary orientation of the reservoir and condensate pump;

FIG. 1D is a component view of an exemplary reservoir and exemplary condensate pump, as components of a kit;

FIG. 2A is a side view of an exemplary reservoir of an exemplary air handling system of the present disclosure;

FIG. 2B is an exploded view of the exemplary reservoir of FIG. 2A;

FIG. 3 is a front perspective view of the exemplary reservoir of FIG. 2A;

FIG. 4 is a view of the exemplary reservoir of FIG. 2A along line 4;

FIG. 5 is a rear perspective view of the exemplary reservoir of FIG. 2A;

FIG. 6 is a front perspective view of an exemplary condensate pump according to an embodiment of the present disclosure;

FIG. 7 is a rear perspective view of the exemplary condensate pump of FIG. 6 according to an embodiment of the present disclosure;

FIG. 8 is a side perspective view of an exemplary reservoir of FIG. 2A and an exemplary condensate pump of FIG. 6 in a ninety degree orientation with a retainer;

FIG. 9 is a side perspective view of an exemplary reservoir of FIG. 2A and an exemplary condensate pump of FIG. 6 in a ninety degree orientation with an exemplary retainer of FIG. 8 included with a mounting bracket;

FIG. 10A is a processing sequence depicting an operation of the reservoir according to an embodiment of the present disclosure;

FIG. 10B is a processing sequence depicting an operation of the reservoir with low sensor failure detection according to an embodiment of the present disclosure;

FIG. 10C is a processing sequence depicting an operation of the reservoir with sensor failure detection according to an embodiment of the present disclosure;

FIG. 10D is a processing sequence depicting an operation of the reservoir according to FIG. 10C without sensor failure detection according to an embodiment of the present disclosure;

FIG. 11 is a processing sequence of a controller of the system of FIG. 9 according to an embodiment of the present disclosure;

FIG. 12 is a side perspective view of a conduit according to an embodiment of the present disclosure positioned on a wall and including a detachable mounting guide for positioning a condensate reservoir and fluid pump external to the conduit;

FIG. 13 is a side perspective view of the conduit of FIG. 12 with the mounting guide removed, a reservoir bracket for attachment to the wall, and a pump bracket for attachment to the wall according to an embodiment of the present disclosure;

FIG. 14 is a side perspective view of the conduit, the reservoir bracket, and the pump bracket of FIG. 13 mounted to the wall according to an embodiment of the present disclosure;

FIG. 15 is a side perspective view of a cover which couples to the conduit and covers the conduit, the reservoir bracket, and the condensate bracket according to an embodiment of the present disclosure;

FIG. 16 is a top sectional view of the arrangement of FIG. 15 taken along line 16-16 according to an embodiment of the present disclosure;

FIG. 17 is a rear perspective view of the conduit of FIG. 14, with a reservoir unit coupled to the reservoir bracket and a pump unit coupled to the pump bracket according to an embodiment of the present disclosure;

FIG. 18 is a front perspective view of the arrangement of FIG. 17;

FIG. 18A is a front view of the arrangement of FIG. 17 and illustrating the cooling lines of an air handling system and a condensate line of the air handling system;

FIG. 19 is an exploded view of a reservoir unit, a reservoir bracket, a pump unit, and a pump bracket according to an embodiment of the present disclosure;

FIG. 20 is a side cut-away view of the reservoir unit of FIG. 19;

FIG. 21 is a perspective view of a float according to an embodiment of the present disclosure of the reservoir unit;

FIG. 22 is a sectional view of an exemplary grommet taken along line 22-22 of FIG. 17, showing a bracket of the reservoir unit not seated within the grommet supported by the reservoir bracket;

FIG. 23 is a sectional view of an exemplary grommet taken along line 22-22 of FIG. 17, showing the bracket of the reservoir unit seated within the grommet supported by the reservoir bracket;

FIG. 24 is a top view of the reservoir of FIG. 19 secured to the reservoir bracket of FIG. 19;

FIG. 25 is an exemplary view of magnetic field lines from a magnet in an exemplary float structure.

Corresponding reference characters indicate corresponding parts throughout the several views. Unless otherwise stated, the drawings are proportional. The exemplifications set out herein illustrate exemplary embodiments of the disclosure and such exemplifications are not to be construed as limiting the scope of the disclosure in any manner.

### DETAILED DESCRIPTION OF THE DRAWINGS

The embodiments of the disclosure described herein are not intended to be exhaustive or to limit the disclosure to the precise forms disclosed. Rather, the embodiments selected for description have been chosen to enable one skilled in the art to practice the subject matter of the disclosure. Although the disclosure describes specific configurations of a air handling system, it should be understood that the concepts presented herein may be used in other various configurations consistent with this disclosure.

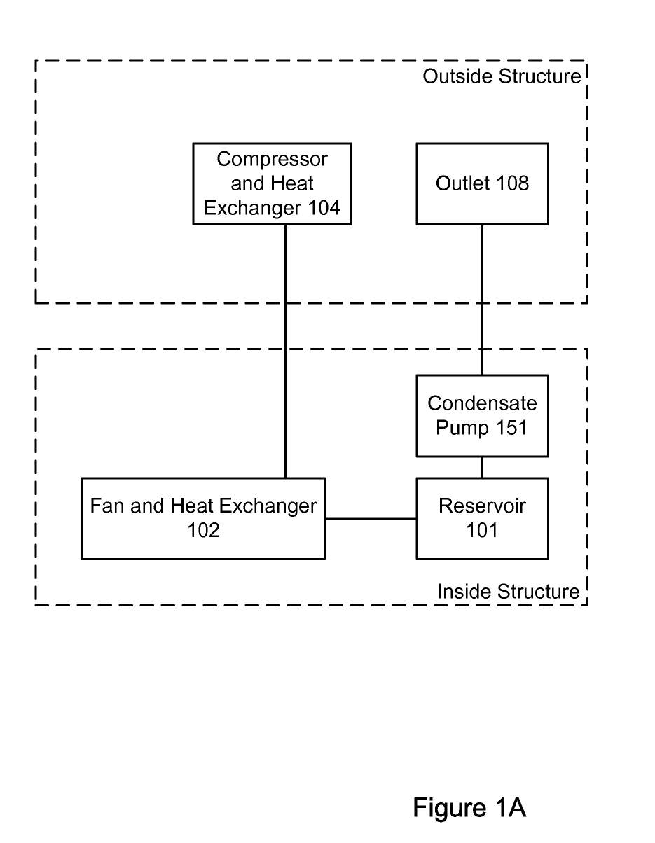

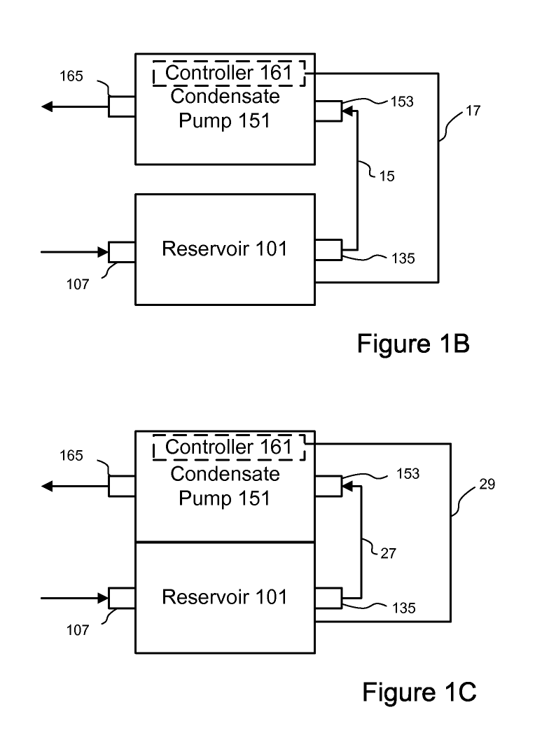

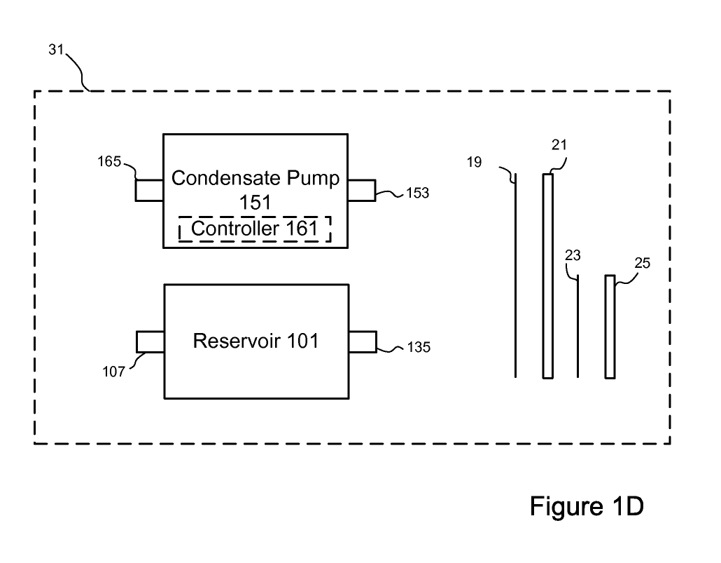

FIG. 1A is a component view of an exemplary air handling system of the present disclosure. FIG. 1A shows a fan and heat exchanger 102 in communication with a compressor and heat exchanger 104. The fan and heat exchanger 102 is also in communication with a reservoir 101. The reservoir 101 is in communication with a condensate pump 151, and the condensate pump 151 is in communication with an outlet 108. The compressor and heat exchanger 104 may receive warm coolant, possibly in a gas form, from the fan and heat exchanger 102. The compressor and heat exchanger 104 compresses the coolant gas into a liquid or otherwise removes heat from the coolant. The compressed coolant is transferred to the fan and heat exchanger 102 within the structure. The fan may direct air within the structure across the heat exchanger or pull air across the heat exchanger, such that the coolant takes on heat from the air resulting in the air being cooled. The now warmed coolant travels back in a substantially closed loop to the compressor and heat exchanger 104 to be cooled.

The cooling of the air inside the structure condenses moisture from the air onto the heat exchanger in the form of a liquid or a solid. The condensate may be removed from the fan and heat exchanger 102 and may be transferred to the reservoir 101. The condensate may be transferred to the reservoir 101 by, for example and without limitation, gravity or a pump. The condensate may flow through a flexible or a rigid tube or trough, or the reservoir 101 may be positioned below the fan and heat exchanger 102 to catch falling material.

The reservoir 101 may collect the condensate condensed from the ambient air by the fan and heat exchanger 102. The reservoir 101 may include one or more sensors to detect the level of condensate within the reservoir 101, and the information regarding the level of condensate may be transmitted to a controller 161 (shown, for example, in FIG. 7), which may take an action based on the level of condensate in the reservoir 101. For example, if the sensors in the reservoir 101 indicate that the level of the condensate has reached a predetermined point, the controller 161 may energize the condensate pump 151 to remove some or all of the condensate from the reservoir 101. The reservoir 101 and the operation of the reservoir 101 and the condensate pump 151 are described in more detail below.

The condensate pump 151 may operate to remove condensate from the reservoir 101. The condensate may flow from the reservoir 101 to the condensate pump 151 through a flexible or a rigid tube or trough. In an embodiment, the condensate pump 151 may be an electric pump with an input and an output. The input may be connected to the reservoir 101, so that condensate may flow from the reservoir 101 to the condensate pump 151. The condensate may flow through the condensate pump 151 to the output of the condensate pump 151, and may flow to the outlet 108 of the air handling system via a flexible or a rigid tube or trough. In an embodiment, the condensate pump 151 may not be included, and the condensate may be removed, for example, as it evaporates from the reservoir 101. In another embodiment, the condensate pump 151 may not be included, and the condensate may flow from the reservoir 101 to the outlet 108 using another process. For example, and without limitation, the condensate may flow from the reservoir 101 to the outlet 108 by gravity. The condensate pump 151 and the operation of the reservoir 101 and the condensate pump 151 is described in more detail below.

The outlet 108 may be positioned inside or outside of the structure. The outlet 108 may be a drain or other structure that disposes of the condensate. In an embodiment, the outlet 108 may be a reservoir, to collect and retain the condensate liquid. For example, the reservoir 101 may collect the condensate liquid so that the condensate liquid may be recycled and used for other purposes.

The fan and heat exchanger 102, the reservoir 101, and the condensate pump 151 may be inside of a structure. The structure may, for example and without limitation, be a building. The compressor and heat exchanger 104, and the outlet 108, may be outside of the structure. In embodiments, some or all of the components may be inside the structure, and in other embodiments, some or all of the components may be outside the structure. If the components are positioned outside of the structure, then the fan and heat exchanger 102 may be positioned, for example, to remove warm air from inside the structure and to move cooled air inside the structure by one or more vents or tubes between the fan and heat exchanger 102 and the inside of the structure.

The temperature of the ambient air inside the structure and outside the structure, and the noise requirements for components inside the structure or outside the structure, may influence the positioning of the components. For example, the compressor may generate noise, and in an effort to reduce the noise inside the structure, the compressor may be positioned outside of the structure. Generally, to cool the ambient air inside a structure, the heat exchanger 102 may be positioned inside the structure, and the heat exchanger 104 may be positioned outside of the structure. Some or all of the components may also be positioned in the same structure. For example, and without limitation, the components 102, 101, 151, 108, and 104 may be positioned within a window, a ceiling mounted structure, or a wall mounted structure.

Turning now to FIGS. 1B, 1C, and 1D, FIG. 1B is a component view of an exemplary reservoir 101 and exemplary condensate pump 151, showing an exemplary orientation of the reservoir 101 and condensate pump 151. FIG. 1C is a component view of an exemplary reservoir 101 and exemplary condensate pump 151, showing an additional exemplary orientation of the reservoir 101 and condensate pump 151. FIG. 1D is a component view of an exemplary reservoir 101 and exemplary condensate pump 151, as components of a kit.

FIG. 1B shows a condensate pump 151 and a reservoir 101 that are separate from one another, but are in communication. Condensate may flow into the reservoir 101 via the inlet port 107, may flow from the outlet port 135 of the reservoir 101, through a tube 15, and into the condensate pump 151 via the condensate pump inlet port 153, and may flow out of the condensate pump 151 via the condensate pump outlet port 165. The condensate pump 151 includes a fluid pump for pumping condensate fluid from inlet port 153 to output port 165. The fluid pump is housed within a pump housing.

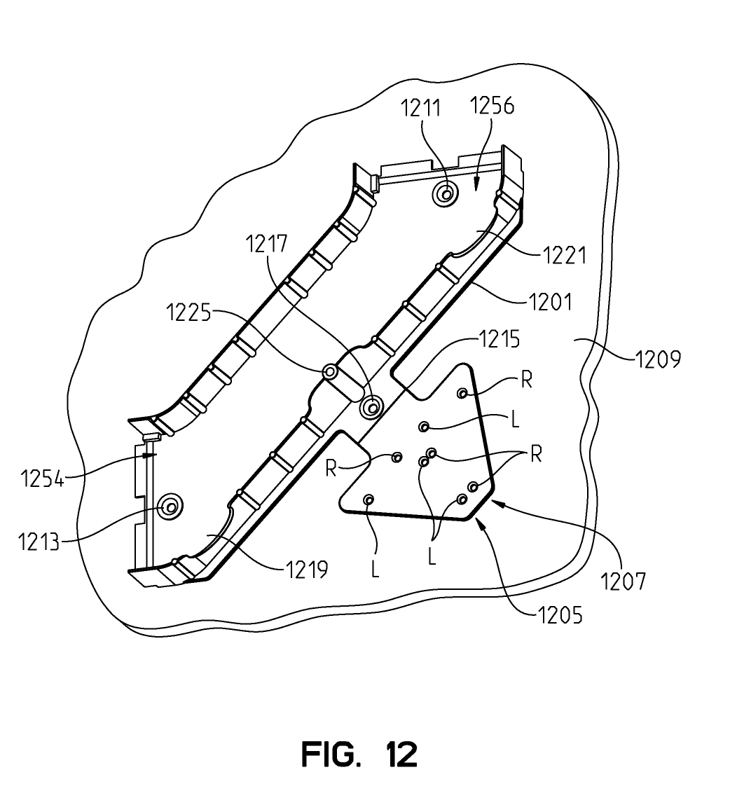

The reservoir 101 and the condensate pump 151 may be mounted separately from one another. For example, the reservoir 101 may be mounted so that condensate may flow into the reservoir 101 via gravity, and the condensate pump 151 may be mounted apart from the reservoir 101, so that condensate may be removed from the reservoir 101 via the condensate pump 151. In one embodiment, the reservoir 101 and the condensate pump 151 may be mounted to ductwork. In another embodiment, the reservoir 101 and the condensate pump 151 may be mounted with fasteners, snap features, interlocking features, or other suitable devices. In one embodiment, the reservoir 101 and the condensate pump 151 are mounted outside of the ductwork. An exemplary embodiment is shown in FIGS. 12-21 and described herein.

The reservoir 101 may be in electrical communication with the condensate pump 151 and/or the controller 161 (not shown in FIG. 1A) to allow, for example and without limitation, sensors (not shown) in the reservoir 101 to be in communication with the condensate pump 151 and/or the controller 161. Although shown associated with the condensate pump 151, controller 161 may be associated with reservoir 101, or the functions of the controller 161 may be split between the reservoir 101 and the condensate pump 151, or other structures. The electrical communication may be accomplished with the use of one or more wiring harnesses 17. The ends of the one or more wiring harnesses 17 may include one or more connections that are keyed. For example, the connections may include one or more projections, so that the connectors may be assembled in a limited number of directions. The keyed connectors assemble to mating connectors on one or both of the reservoir 101 and the condensate pump 151 so that improper installation is reduced or eliminated. The tube 15 and the one or more wiring harnesses 17 may be sized so that their length allows the reservoir 101 and the condensate pump 151 to remain in communication. In other embodiments, the reservoir 101 and the condensate pump 151 may communicate wirelessly via one or more wireless links as opposed to or in addition to one or more wiring harnesses 17.

FIG. 1C shows a condensate pump 151 and a reservoir 101 that are joined together. Condensate may flow in a similar manner as illustrated in FIG. 1B, but the reservoir 101 and the condensate pump 151 may be attached to one another by, for example and without limitation, projections or clips present on one or both of the reservoir 101 and the condensate pump 151. The reservoir 101 and the condensate pump 151 may be attached in other ways as well. For example, the reservoir 101 and the condensate pump 151 may be bonded together, or the reservoir 101 and the condensate pump 151 may be a single piece, or the reservoir 101 and the condensate pump 151 may be housed in an additional component or a portion of ductwork that positions the reservoir 101 and the condensate pump 151 next to one another, or coupled together with fasteners. A tube 27 may connect the outlet port of the reservoir 101 with the inlet port of the condensate pump 151, and the reservoir 101 and the condensate pump 151 may be in electrical communication with the use of one or more wiring harnesses 29. The tube 27 and the one or more wiring harnesses 29 may be shorter in length than the tube 15 and the one or more wiring harnesses 17 shown in FIG. 1B, as the reservoir 101 and the condensate pump 151 may be closer together and the extra length may not be desirable. In other embodiments, the reservoir 101 and the condensate pump 151 may communicate wirelessly via one or more wireless links as opposed to or in addition to the one or more wiring harnesses 29.

FIG. 1D shows an exemplary kit 31 containing a reservoir 101, a condensate pump 151, a long wiring harness 19, a long tube 21, a short wiring harness 23, and a short tube 25. The short wiring harness 23 and the short tube 25 may be used to connect the reservoir 101 and the condensate pump 151 if the reservoir 101 and the condensate pump 151 are attached to each other or if the reservoir 101 and the condensate pump 151 are installed a short distance from one another. The long wiring harness 19 and the long tube 21 may be used to connect the reservoir 101 and the condensate pump 151 if the reservoir 101 and the condensate pump 151 are attached to each other or if the reservoir 101 and the condensate pump 151 are installed a longer distance from one another, such that the short wiring harness 23 and the short tube 25 may not allow communication between the reservoir 101 and the condensate pump 151. In one embodiment, the long tube 21 and the short tube 25, and the long electrical harness 19 and the short electrical harness 23, may be shortened by, for example, cutting, to use shorter lengths if required or desirable. In one embodiment, the long tube 21 is about 40 inches in length, the short tube 23 is about 7 inches in length, the long wiring harness 19 is about 40 inches in length, and the short wiring harness 23 is about 7 inches in length. In one embodiment, the long tube 21 is at least about 40 inches in length, the short tube 23 is at least about 7 inches in length, the long wiring harness 19 is at least about 40 inches in length, and the short wiring harness 23 is at least about 7 inches in length. In one embodiment, the long tube 21 is up to about 40 inches in length, the short tube 23 is up to about 7 inches in length, the long wiring harness 19 is up to about 40 inches in length, and the short wiring harness 23 is up to about 7 inches in length. In one embodiment, additional tubes and/or wiring harnesses are provided. In another embodiment, one tube and one wiring harness are provided, and the tube and wiring harness may be cut to an appropriate length. In one embodiment, the additional tubes and/or wiring harnesses are extension tubes and/or extension cables with connectors that are appropriate to extend the length of the tubes and/or harnesses provided.

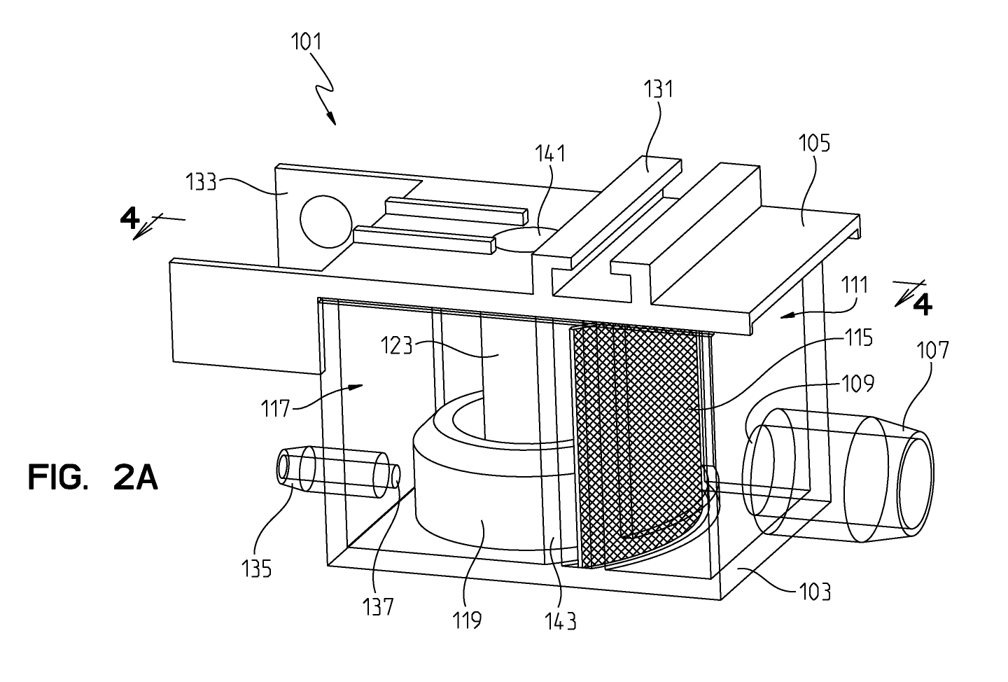

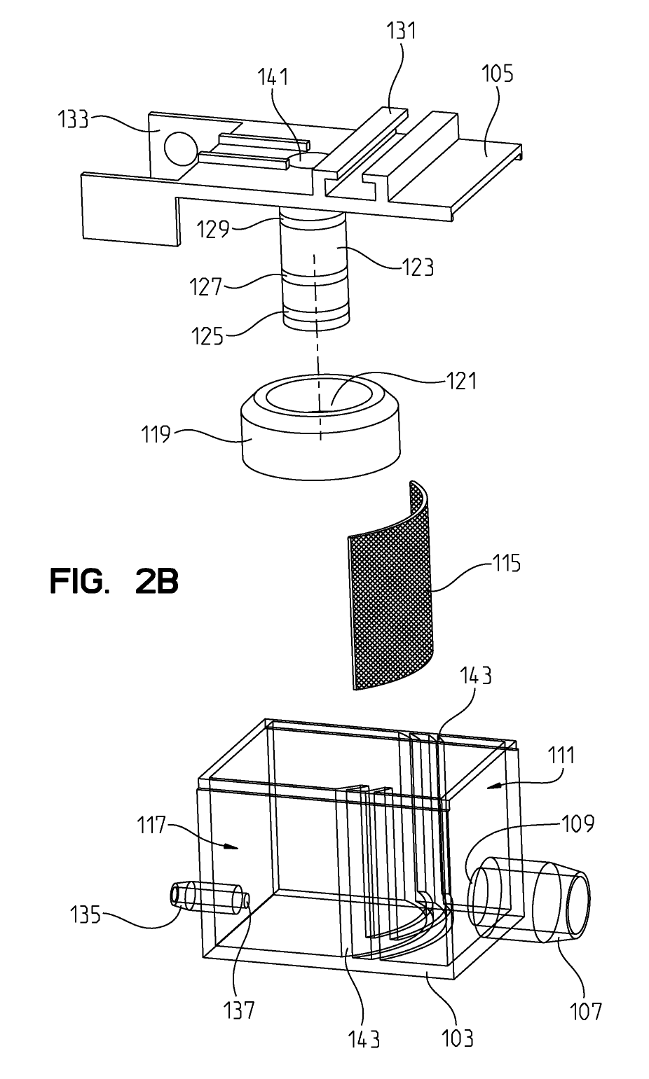

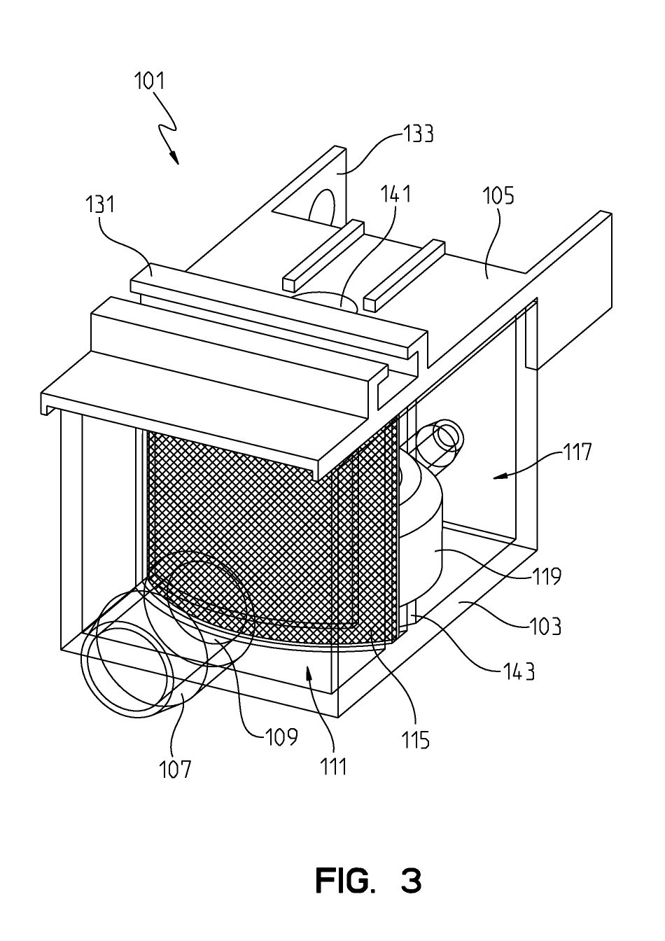

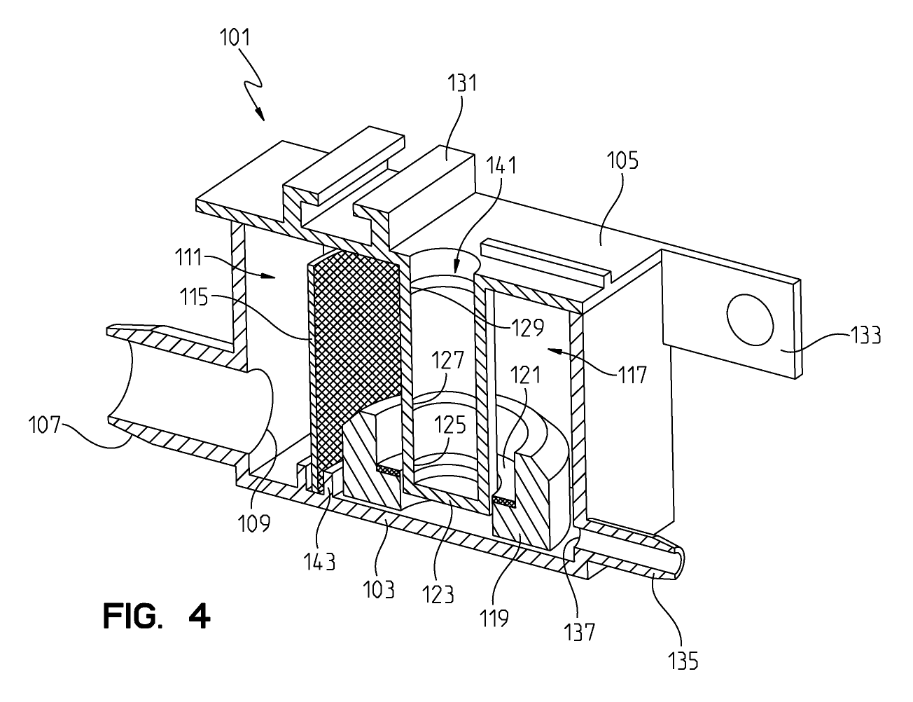

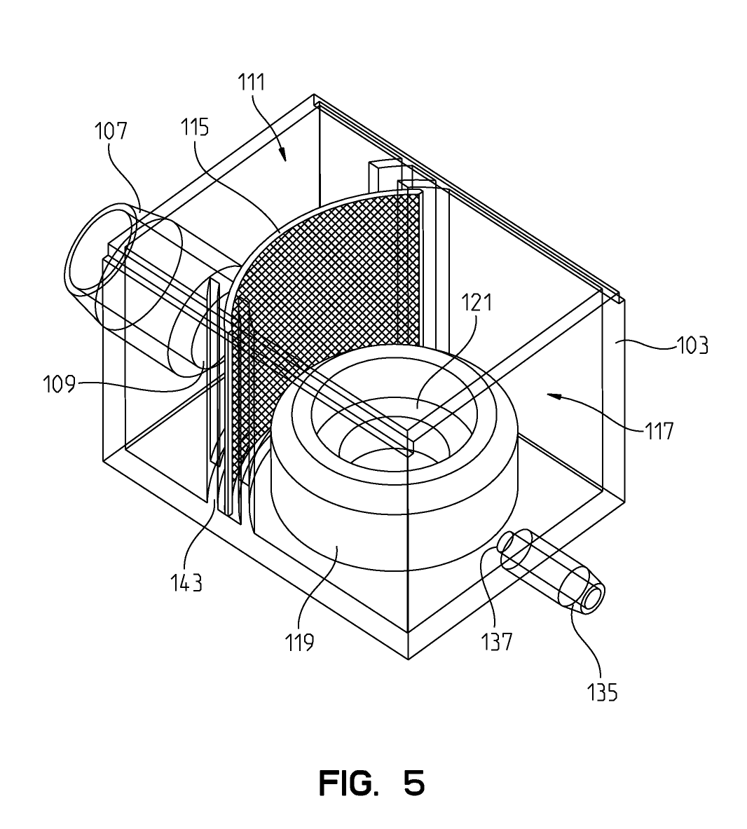

Turning now to FIGS. 2-5, an exemplary reservoir unit of the present disclosure is shown. FIG. 2A is a side view of an exemplary reservoir of an exemplary air handling system of the present disclosure. FIG. 2B is an exploded view of the exemplary reservoir of FIG. 2A. FIG. 3 is a front perspective view of the exemplary reservoir of FIG. 2A. FIG. 4 is a view of the exemplary reservoir of FIG. 2A along line 4. FIG. 5 is a rear perspective view of the exemplary reservoir of FIG. 2A.

Referring to FIG. 2A, an exemplary embodiment of reservoir 101 is shown. Reservoir 101 includes a basin 103 and a top structure 105. Basin 103 includes a first chamber 111 and a second chamber 117 both for holding a condensate, an inlet port 107 for receiving the condensate into the basin 103, and an outlet port 135 through which the condensate may exit the basin. The first chamber 111 and the second chamber 117 are in fluid communication and are separated by a screen 115. As illustrated, a single inlet port 107 and a single outlet port 135 are provided. In one embodiment, multiple inlet ports and/or outlet ports are provided.

The basin 103 may be a single piece, or may be one or more parts that are fastened or fused together. In one embodiment, the basin 103 is substantially optically transparent, so that the level of condensate and/or the overall operation of the reservoir 101 may be monitored without disassembling the reservoir 101. The basin 103 comprises an inlet port 107, an outlet port 135, and a screen retaining structure 143. In another embodiment, the inlet port 107, the outlet port 135, and the screen retaining structure 143 may be attached to the basin 103. The basin 103 may also include one or more retainers that releasably engage with or otherwise cooperate with one or more retainers located on the top structure 105. Exemplary retainers include clips, fasteners, snap features, and other suitable devices to hold or constrain the relative position of two components in at least one degree of freedom. The basin 103 may also have a lip or groove that may engage with a similar lip or groove on the top structure 105, in order to form a seal so that condensate or other material may not escape from the interface between the basin 103 and the top structure 105, when the basin 103 and the top structure 105 are engaged.

The inlet port 107 and the outlet port 135 may be the same material as the basin 103. The inlet port 107 may be a part of the basin 103 or assembled thereto. In another embodiment, the inlet port 107 and the outlet port 135 may be a different material as the basin 103, or may be attached to the basin 103. The inlet port 107 surrounds a void 109 in the basin 103 in communication with the first chamber 111. The inlet port 107 releasably engages with a rigid or flexible connector to receive condensate from an air handling system. For example, and without limitation, the inlet port 107 may connect to a flexible tube, so that condensate and/or particulate matter flows through the flexible tube, through the inlet port 107, through the inlet port void 109, and into the first chamber 111 of the reservoir 101.

The outlet port 135 surrounds a void 137 in the basin 103 in communication with the second chamber 117. The outlet port 135 releasably engages with a rigid or flexible connector to allow condensate to flow from the second chamber 117 to the condensate pump 151. For example, and without limitation, the outlet port 135 may connect to a flexible tube, so that condensate and/or particulate matter flows from the second chamber 117 of the reservoir 101, through the outlet port void 137, through the flexible tube, and to the condensate pump 151.

The top structure 105 may be the same material as the basin 103, or may be a different material. For example, and without limitation, the basin 103 is substantially optically transparent. The top structure 105 includes a top hinge member 133, a top bracket 131, and the float support 123. In one embodiment, one or more of 131, 133, and 135 are a part of or assembled to reservoir 101. The top hinge member 133, the top bracket 131, and the float support 123 are integrated into the top structure 105. In another embodiment, the top hinge member 133, the top bracket 131 and/or the float support 123 may be separate from the top structure 105, and attached to the top structure 105.

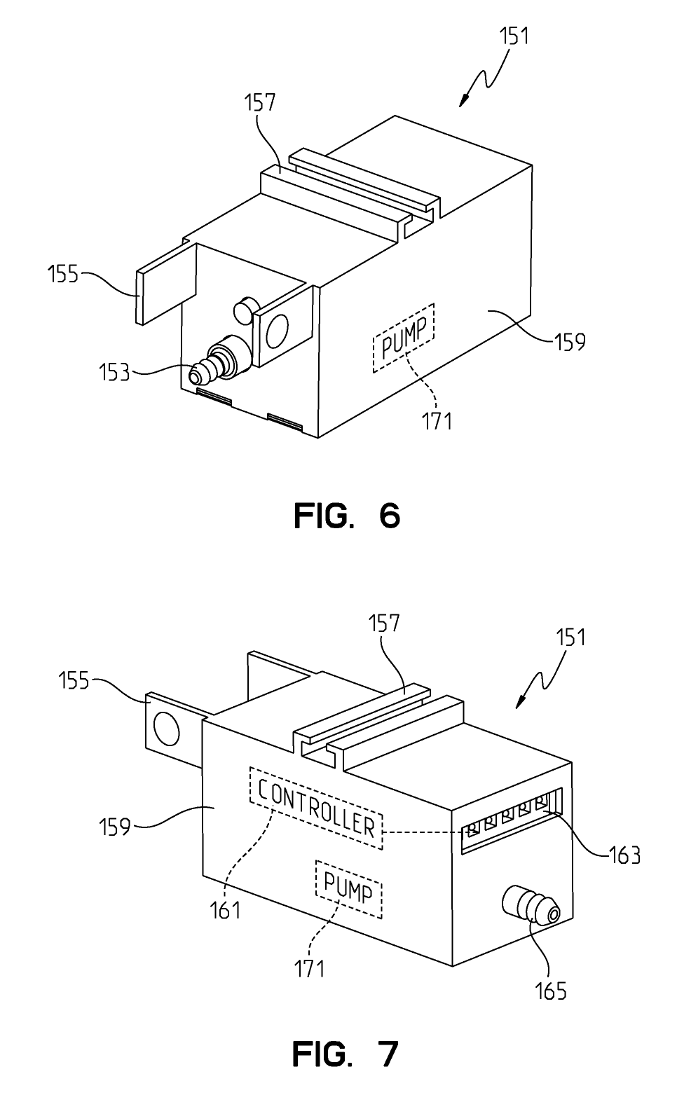

The top hinge member 133 may include one or more projections or one or more voids, to allow the top hinge member 133 to be releasably connected to a pump hinge member 155 of the condensate pump 151 (see FIG. 6). As explained herein, the hinge member 133 and the pump hinge member 155 cooperate to couple reservoir 101 and condensate pump 151 together while permitting relative movement there between. The float support 123 extends from the surface of the top structure 105 into the basin 103. The float support 123 interacts with a receiving structure inside the basin 103, so that the float support 123 and/or the receiving structure extend through the basin 103 from the top structure 105 to the base of the basin 103. The float support 123 also includes a void 141 extending from the upper surface of the top structure 105, through the top structure 105 and into the float support 123. One or more sensors are be attached to one or more of the walls of the void 141, which interact with the magnet or magnets 121 attached to the float 119.

When the top structure 105 is releasably engaged with the basin 103, the float support 123 extends into the basin 103, and the float 119 surrounds the float support 123 so that the movement of the float 119 is substantially constrained except for movement towards the top structure 105 and away from the top structure 105. The groove or lip of the basin 103 and the groove or lip of the top structure 105 may engage, so as to form a seal to substantially contain the condensate within the basin 103 from escaping from the interface between the top structure 105 and the basin 103. The top hinge member 133 extends from the reservoir 101 in the direction of the outlet port 135.

The float 119 may be a closed cell foam material, for example Styrofoam, or may be an enclosed plastic material. The float 119 substantially surrounds or completely surrounds the float support 123, so that the float 119 travels along the float support 123. The float 119 may be a material or may be oriented in a way so that it is less dense than the condensate liquid, allowing the float 119 to rise and fall along the float support 123 axis in response to the level of condensate liquid in the second chamber 117. If no condensate liquid is in the second chamber 117, for example, the float 119 may rest on the lower inner surface of the basin 103. If the second chamber 117 is full of condensate liquid, the float 119 may rest at or near the upper inner surface of the basin 103. The float 119 additionally has one or more magnets 121 (see FIG. 4) deposited on the surface of the float 119 or embedded within the float 119. The magnets 121 interact with one or more sensors in the float support 123 to indicate the amount of condensate liquid in the second chamber 117. In one embodiment, the float 119 may be symmetrical, and the magnet or magnets 121 may be centered vertically on the float 119, so that the float 119 could be installed around the float support 123 in either orientation and the magnet or magnets 121 would interact with the one or more sensors 125, 127, 129 in the float support 123.

Screen retaining structure 143 captures or otherwise holds a screen 115 which divides the basin 103 into a first chamber 111 and a second chamber 117, and allows condensate to pass from the first chamber 111 to the second chamber 117, but may stop debris and other particulate matter from passing from the first chamber 111 to the second chamber 117. The screen 115 may be a rigid or flexible material containing a plurality of openings through the screen 115. The openings may be of any size, shape, and number to selectively allow material to pass from the first chamber 111 to the second chamber 117. The openings may be sized to allow condensate and material of a certain size to pass from the first chamber 111 to the second chamber 117, or may be sized to allow condensate, while excluding substantially all other matter from passing from the first chamber 111 to the second chamber 117. The screen 115 may be releasably engaged by the screen retaining structure 143 of the basin 103, so that the base and sides of the screen 115 are held in place by the screen retaining structure 143.

The screen 115 may be of a semi-circular shape. In one embodiment, and as shown in FIG. 5, the screen 115 extends toward the inlet opening. In another embodiment, the screen 115 extends away from the inlet opening. In yet another embodiment, the screen 115 is substantially flat, and extends across the basin 103. The screen 115 may be removable, so that the top structure 105 of the basin 103 may be removed and the screen 115 may be removed from the basin 103. The screen 115 may be removable for cleaning or replacement. In one embodiment, screen 115 is positioned on an opposite side of float 119 such that float 119 is in the first chamber 111 and responds to the level of condensate liquid in the first chamber 111.

Shown in FIG. 2B and FIG. 4, the high sensor 129, the medium sensor 127, and the low sensor 125 may be attached to the inner void 141 of the float support 123, and interact with the magnet or magnets attached to the float 119. For example, the sensors may be Hall-effect sensors, or may be reed switches. The magnetic field of the magnet or magnets 121 in the float 119 interacts with one or more of the sensors, depending on the position of the float 119 along the float support 123, the relative placement of the sensors, and the magnetic field strength of the magnet or magnets 121. For example, if the float 119 is at or near the base of the basin 103, the magnet or magnets 121 in the float 119 would interact with the low sensor 125, but would not interact with the medium sensor 127 or the high sensor 129. If the float 119 is in or near the middle of the basin 103, the magnet or magnets 121 in the float 119 would interact with the medium sensor 127, but would not interact with the low sensor 125 or the high sensor 129. If the float 119 is at or near the top structure 105 of the basin 103, adjacent to the top structure 105, the magnet or magnets 121 in the float 119 would interact with the high sensor 129, but would not interact with the low sensor 125 or the medium sensor 127. In other embodiments, the position of the float 119 may activate multiple sensors, based on the spacing of the sensors. For example, if the float 119 was between the low sensor 125 and the medium sensor 127, both the low sensor 125 and the medium sensor 127 may be activated. This may provide increased resolution on the relative position of the float 119. In other embodiments, more or fewer sensors may be used to detect the position of the float 119. While the exemplary reservoir includes magnetic sensors, such as Hall-effect sensors or reed switches, other sensors may be used to detect the float 119 position within the basin 103. For example, and without limitation, optical sensors may be used to measure condensate volume, or sensors to measure the weight of the condensate may be used. Sensors may also be used in a way that a float 119 may be optional. In one embodiment, the high sensor 129, the medium sensor 127, and the low sensor 125 are attached to a circuit board which is positioned within void 141.

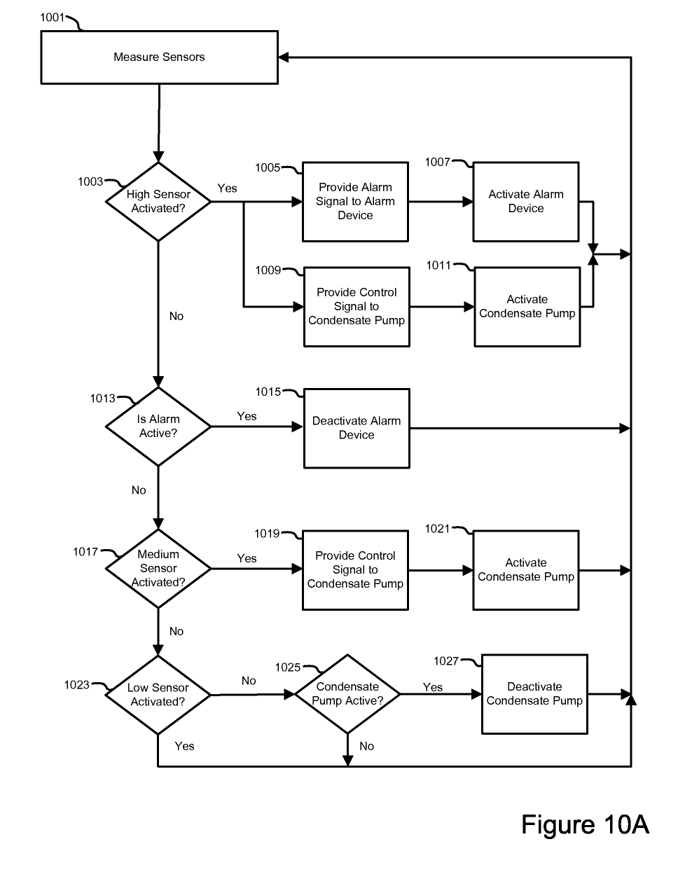

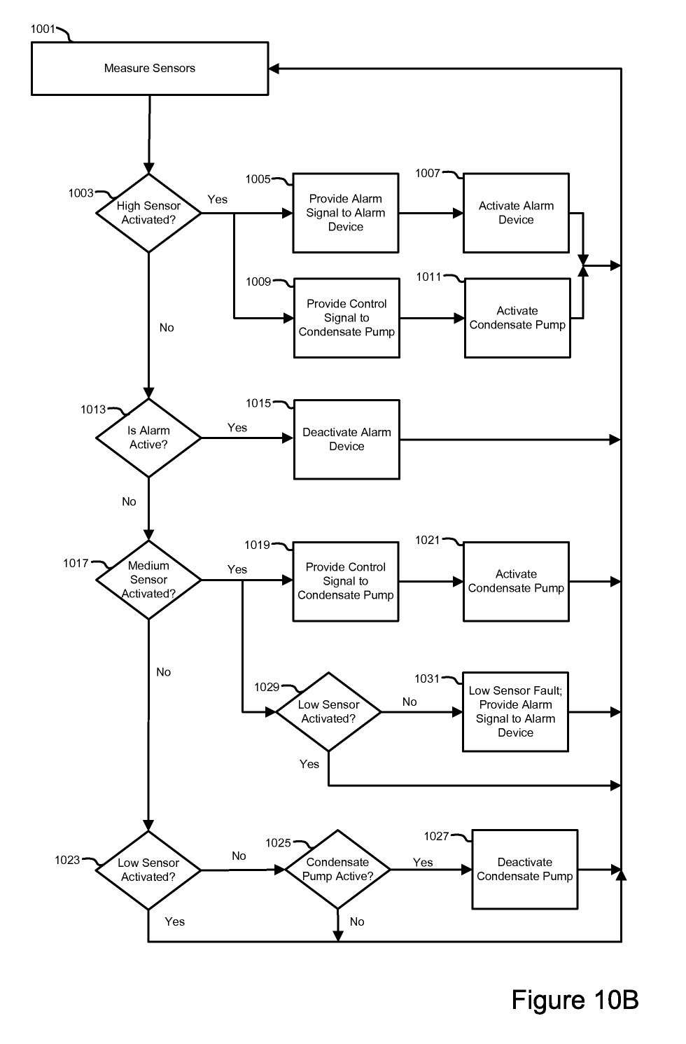

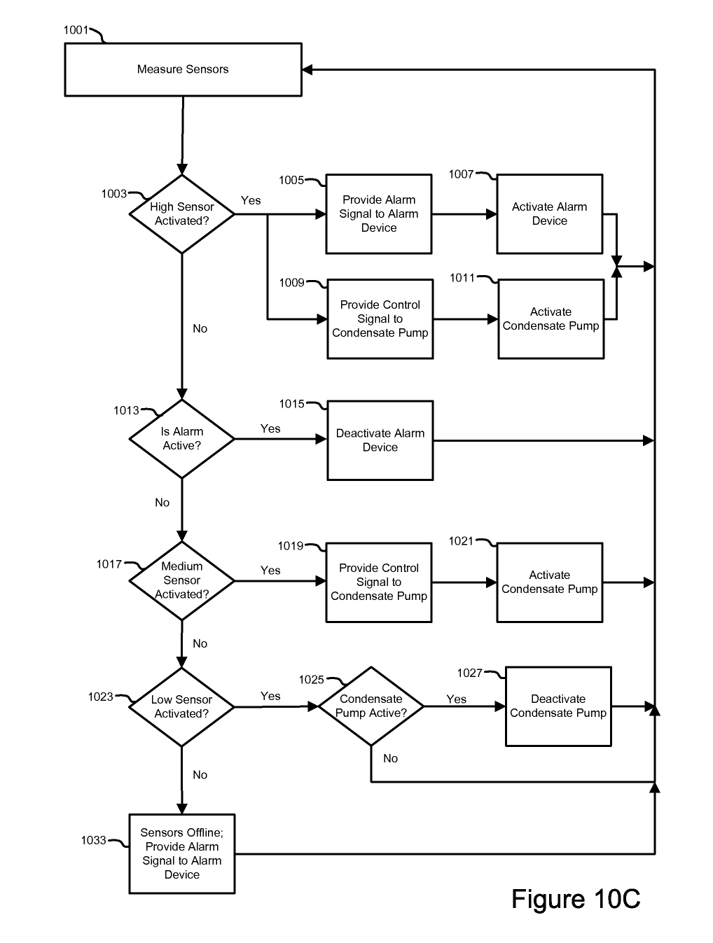

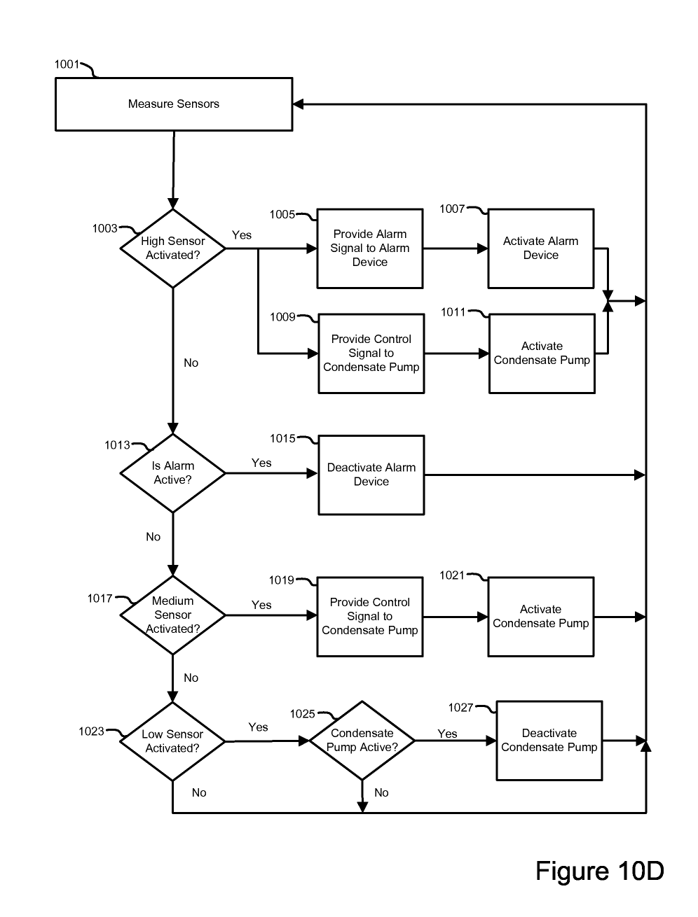

Turning now to FIG. 10A, a flow chart depicting an operation of the reservoir 101 is shown. As represented in block 1001, the controller 161 measures the sensors. The controller 161 requests data from the sensors, or monitors the sensor inputs to determine if a sensor is activated.

As represented in block 1003, if the high sensor 129 is activated, the float 119 is positioned at or near the top structure 105 of the basin 103, adjacent to the top structure 105, or at the top structure 105 of the float support 123. The controller 161 may interpret a signal from the high sensor 129 as an indication that the condensate pump 151 has failed, or that condensate is flowing into the second chamber 117 faster than the condensate pump's ability to remove condensate. As represented in block 1005, the controller 161 provides an alarm signal to an alarm device. The alarm device may activate, as represented in block 1007. The alarm device may be associated with the controller 161, and the alarm device takes one or more actions to provide an alert or to reduce possible damage to the system. For example, the alarm device may shut off the air conditioning system, so that the fan and heat exchanger does not produce additional condensate. The alarm device may activate one or more warning indicators, for example a light or warning message, on a panel to indicate to a user that the system may be in a fault state. Or the alarm device may send a message to another system, such as over a telephone line, a cellular connection, or a computer network, to communicate the alert.

The controller 161 also provides a control signal to the condensate pump 151, as represented in block 1009. As represented in block 1009, the controller 161 provides a control signal to the condensate pump 151, and as represented in block 1011, the condensate pump 151 activates in response to the control signal from the controller 161, and removes condensate from the second chamber 117. In one embodiment, controller 161 simply provides or cuts power to the condensate pump 151. The controller 161 continues to measure the sensors, as represented in block 1001. If the high sensor 129 is not activated, the controller may proceed to other tasks, as represented in block 1013.

As represented in block 1013, the controller 161 determines if an alarm signal has been provided to the alarm device. If an alarm signal has been provided to the alarm device, and the high sensor 129 is not activated, the controller 161 terminates the alarm event, and stops the alarm signal or sends a separate signal to indicate the termination of the alarm signal, as represented in block 1015. If the alarm is not active, the controller 161 may proceed to other tasks, as represented in block 1017.

As represented in block 1017, if the medium sensor 127 is activated, the float 119 is positioned at or near the middle of the basin 103, or the midpoint of the float support 123. The controller 161 interprets an activation of the medium sensor 127 as an indication that enough condensate is in the second chamber 117 to activate the pump and begin to remove condensate from the second chamber 117. As represented in block 1019, the controller 161 provides a control signal to the condensate pump 151, and as represented in block 1021, the condensate pump 151 activates in response to the control signal from the controller 161, and removes condensate from the second chamber 117. In one embodiment, controller 161 simply provides or cuts power to the condensate pump 151. The controller 161 continues to measure the sensors, as represented in block 1001. If the medium sensor 127 is not activated, the controller may proceed to other tasks, as represented in block 1023.

As represented in block 1023, if the low sensor 125 is activated, the float 119 is at or near the base of the basin 103. The position of the float 119 when the low sensor 125 is activated may indicate that there is little or no condensate in the second chamber 117. The controller 161 determines if the condensate pump 151 is active, as represented in block 1025. If the controller 161 has previously provided a control signal to the condensate pump 151, to activate the condensate pump 151, then the controller 161 deactivates the signal to the condensate pump 151, as represented in block 1027. The controller 161 measures the sensors, as represented in block 1001. If the condensate pump 151 was not active, the controller 161 measures the sensors, as represented in block 1001.

In one embodiment, a single-pole, double throw relay may be utilized in the controller 161, including three wires, corresponding to features of “Common,” “Normally Closed,” and “Normally Open.” The “Common” and “Normally Closed” wires could be connected in series with control wires associated with a thermostat so that if a fault condition occurs, the connection normally running through the control wires may be broken and the compressor may shut down, stopping further condensate creation. The “Common” and “Normally Open” connections may be connected to an alarm or monitoring service to alert a user of a fault condition.

In one embodiment of the design a feature may be added to provide additional feedback to the user whereby a separate wire for “Fault” is incorporated. The control circuitry could switch a voltage to this line on a fault condition such as ‘Overflow’ or ‘Alarm’. This could be configured to switch a low voltage AC signal or a low voltage DC signal or switch mains voltage to the line.

Turning now to FIG. 10B, a processing sequence depicting an operation of the reservoir with low sensor failure detection according to an embodiment of the present disclosure is shown. FIG. 10A and FIG. 10B are similar, except that when the controller 161 determines that the medium sensor 127 is activated, as represented in block 1017, the controller 161 may also determine if the low sensor 125 is activated, as represented in block 1029. If the low sensor 125 is activated, the controller 161 may continue to measure the sensors, as represented in block 1001. If the low sensor 125 is not activated, the controller 161 may determine that the low sensor 125 is in a fault condition, and may provide an alarm signal to an alarm device, as represented in block 1031. The alarm device may operate to inform a user of the fault condition.

Turning now to FIG. 10C, a processing sequence depicting an operation of the reservoir with sensor failure detection according to an embodiment of the present disclosure is shown. FIG. 10A and FIG. 10C are similar, except that, as represented in block 1033, if the controller 161 does not receive a signal from the low sensor 125, the medium sensor 127, or the high sensor 129, the controller 161 may determine that the sensors are offline. For example, the wiring to the sensors may be damaged, or one or more of the sensors may be damaged. The controller 161 provides an alarm signal to an alarm device to indicate the sensors are offline. The alarm device may activate one or more warning indicators, for example a light or warning message, on a panel to indicate to a user that the system may be in a fault state. Or the alarm device may send a message to another system, such as over a telephone line, a cellular connection, or a computer network, or any other network, to communicate the alert. The controller 161 continues to measure the sensors, as represented in block 1001. If, subsequent to providing an alarm signal, the controller 161 receives a signal from the low sensor 125, the medium sensor 127, or the high sensor 129, the controller 161 may stop the alarm signal or send a separate signal to indicate the termination of the alarm signal.

Turning now to FIG. 10D, a processing sequence depicting an operation of the reservoir according to FIG. 10C without sensor failure detection according to an embodiment of the present disclosure is shown. FIG. 10C and FIG. 10D are similar, but the fault detection as represented in block 1033 of FIG. 10c is not present. The sensor fault detection as represented in block 1033 if FIG. 10D may be optional in embodiments.

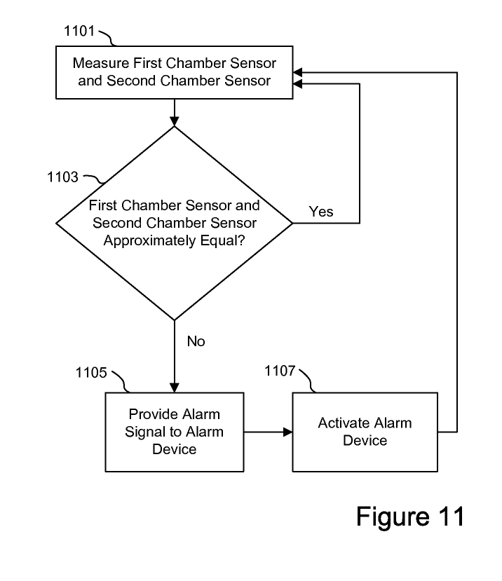

Turning now to FIG. 11, a flow chart depicting a condensate level determination for an exemplary reservoir of the present disclosure is shown. In one embodiment, a first chamber sensor (not shown) is located in the first chamber 111, and a second chamber sensor (not shown) is located in the second chamber 117. The first chamber sensor and the second chamber sensor measure the levels of condensate in the first chamber 111 and the second chamber 117, respectively. The first chamber sensor and the second chamber sensor may be, for example and without limitation, a series of optical sensors extending through the basin 103 to measure the condensate levels, or may be another type of sensor used to measure condensate levels. As represented in block 1101, the controller 161 measures the first chamber sensor and the second chamber sensor. The controller 161 may send the request to the first chamber sensor and the second chamber sensor, or the first chamber sensor and the second chamber sensor may send the information to the controller 161 continuously or at an interval, or a combination of reporting may be used. The controller 161 may interpret the signals received from the first chamber sensor and the second chamber sensor as levels of condensate in the first chamber 111 and in the second chamber 117, respectively, as represented in block 1103. If the condensate levels in the first chamber 111 and the second chamber 117 are approximately equal, the controller 161 may continue to measure the first chamber sensor and the second chamber sensor, as represented in block 1101.

If the condensate levels in the first chamber 111 and the second chamber 117 are not approximately equal, a fault condition may exist. For example, and without limitation, the screen 115 between the first chamber 111 and the second chamber 117 may be clogged with debris, so that condensate cannot move, or may slowly move from the first chamber 111 to the second chamber 117. The controller 161 provides an alarm signal to an alarm device, as represented in block 1105. The alarm device may be associated with the controller 161, and may take one or more actions, as represented in block 1107, to provide an alert or to reduce possible damage to the system. For example, the alarm device may shut off the air conditioning system, so that the fan and heat exchanger do not produce additional condensate. The alarm device may activate one or more warning indicators, for example a light or warning message, on a panel to indicate to a user that the system may be in a fault state. Or the alarm device may send a message to another system, such as over a telephone line, a cellular connection, or a computer network, to communicate the alert. The controller 161 continues to monitor the first chamber sensor and the second chamber sensor, as represented in block 1101. In one embodiment, the user may take an action to stop the fault condition. For example, and without limitation, the user may depress a button to reset the controller 161 and stop the alarm signal. In an embodiment, the controller 161 measures the first chamber sensor and the second chamber sensor, and if the controller 161 had previously determined that the first chamber sensor and the second chamber sensor did not have approximately equal condensate levels, and the levels are now approximately equal, the controller 161 stops the alarm signal. In another embodiment, the controller 161 measures the first chamber sensor and the second chamber sensor one or more times over a period of time, and may not provide an alarm signal until the condensate levels in the first chamber 111 and the second chamber 117 are not approximately equal for a period of time.

Turning now to FIGS. 6 and 7, FIG. 6 is a front perspective view of an exemplary condensate pump 151 according to an embodiment of the present disclosure, and FIG. 7 is a rear perspective view of the exemplary condensate pump 151 of FIG. 6 according to an embodiment of the present disclosure. The condensate pump 151 apparatus includes a pump 171, an inlet port 153, an outlet port 165, and a structure 159. The structure 159 includes a pump hinge member 155 and a pump bracket 157. The structure 159, inlet port 153, outlet port 165, pump hinge member 155, and pump bracket 157 may be the same material in a one-piece construction, or one or more of the elements may be separate and attached together.

The pump 171 creates a lower pressure in the inlet port 153, pulling condensate from the second chamber 117 of the reservoir 101 and through the flexible tube connecting the reservoir 101 to the condensate pump 151. The pump 171 pushes condensate through and out of the outlet port 165. The pump 171 may be similar to the pump described in U.S. Patent Publication No. 2009/0129939, application Ser. No. 11/985,503, entitled “Apparatus for Thermal Dissipation and Retention of Float 119,” and filed Nov. 15, 2007, the disclosure of which is herein incorporated by reference in its entirety. The condensate pump 151 may, for example, include the ability to recirculate condensate past the pump to help cool the pump 171.

The top hinge member 133 of reservoir 101 may interact with the pump hinge member 155 to allow the reservoir 101 and the condensate pump 151 to be connected. The connection allows the reservoir 101 and the condensate pump 151 to be rotated so that the reservoir 101 and the condensate pump 151 may be positioned in line with one another, or the reservoir 101 and the condensate pump 151 may be positioned at a substantially right angle to one another, or the reservoir 101 and the condensate pump 151 may be positioned at any angle between zero degrees (in line) and one hundred thirty degrees. The connection is releasable, so that the condensate pump 151 and the reservoir 101 may be placed separately.

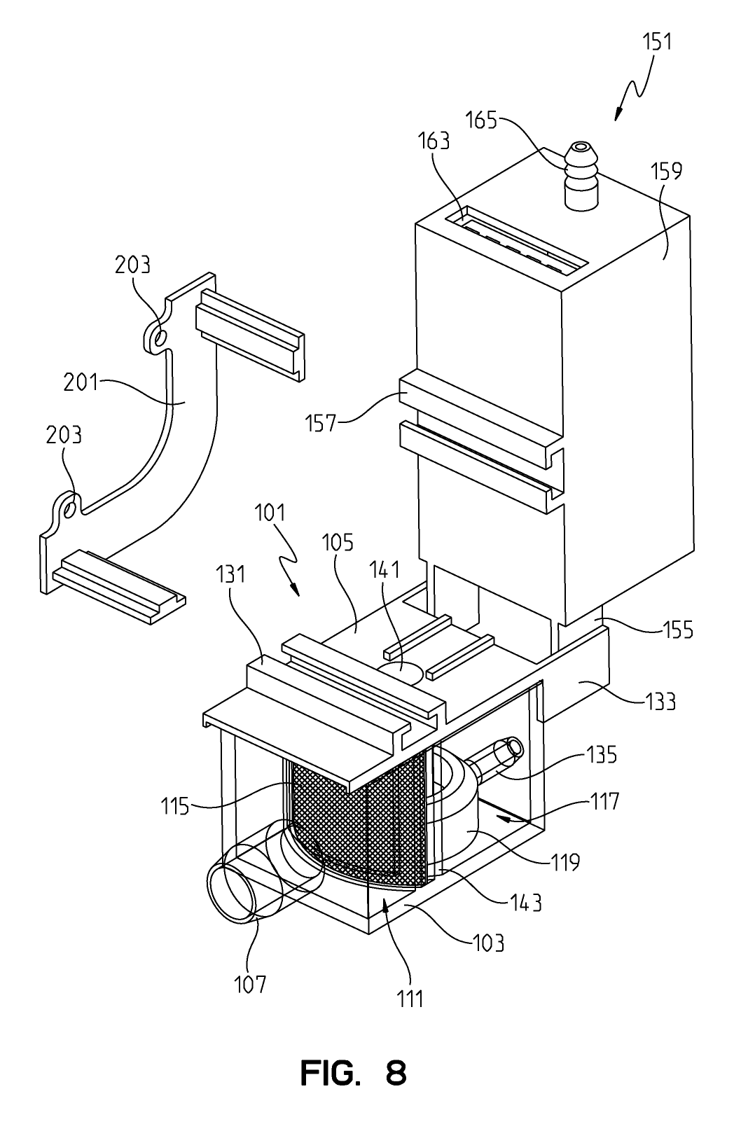

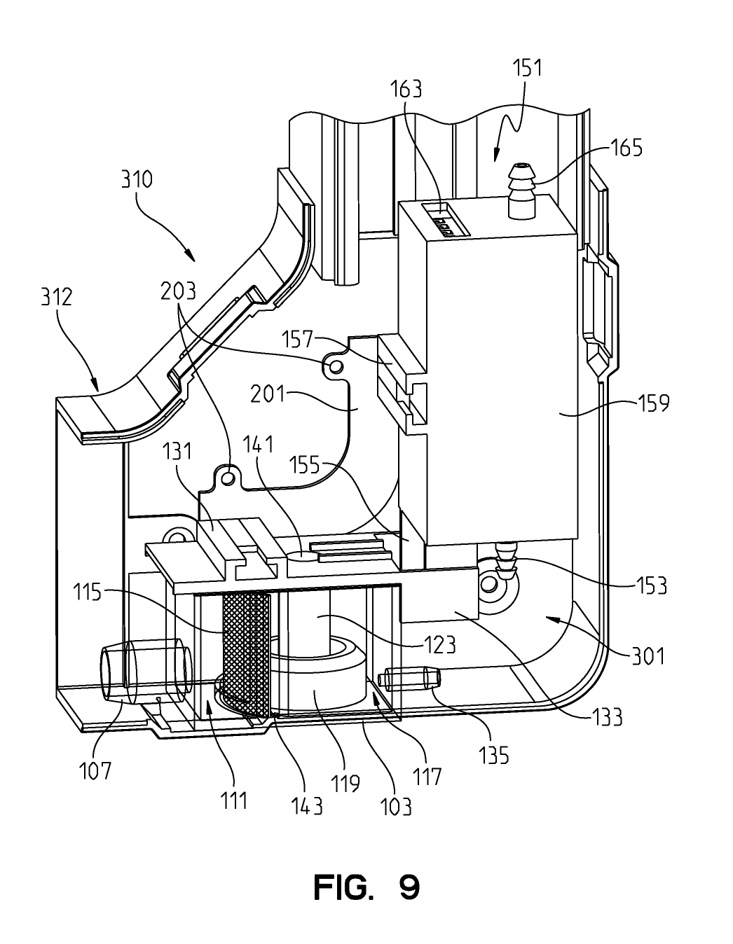

Turning now to FIGS. 8 and 9, FIG. 8 is a side perspective view of an exemplary reservoir of FIG. 2A and an exemplary condensate pump of FIG. 6 in a ninety degree orientation with a retainer 201. FIG. 9 is a side perspective view of an exemplary reservoir of FIG. 2A and an exemplary condensate pump of FIG. 6 in a ninety degree orientation with an exemplary retainer 201 of FIG. 8 included with a mounting bracket. The position of the reservoir 101 and the condensate pump 151 may be releasably locked by the use of a retainer 201. The retainer 201 connects to the top bracket 131 on the reservoir 101 and the pump bracket 157 on the condensate pump 151. For example, the retainer 201 may releasably interact with one or more grooves in the top bracket 131 on the reservoir 101 and the pump bracket 157 on the condensate pump 151. The retainer 201 is a rigid material. An exemplary retainer 201 is shown in FIG. 8. The exemplary retainer 201 interacts with the reservoir 101 and the condensate pump 151 to position the reservoir 101 and the condensate pump 151 at a ninety degree angle. A retainer 201 that positions the reservoir 101 and the condensate pump 151 at other angles may also be used, and a retainer 201 that positions the reservoir 101 and the condensate pump 151 closer or farther apart may also be used. In one embodiment, the retainer 201 may include a hinge or other structure to allow the retainer 201 to position to any angle, and the retainer 201 may include a fastener to reversibly lock the hinge. In one embodiment, the retainer 201 may be integral to the cover, so that the reservoir 101 and the condensate pump 151 may be positioned and releasably held to the cover. The bracket may be located on the cover to position the reservoir 101 and the condensate pump 151 in any orientation and in any distance from one another. The retainer 201, in the illustrated embodiment, includes mounting apertures 203 for securing the retainer 201 to the wall or other support structure.

The controller 161 may be associated with the condensate pump 151, and may be within the same housing as the pump. In one embodiment, the controller 161 is a microprocessor with associated memory. In another embodiment, the controller 161 is another type of analog or digital processor. The controller 161 receives information from one or more sensors that are in communication with the controller 161 via a controller interface 163. For example, the controller 161 is in communication with the high sensor 129, the medium sensor 127, and the low sensor 125 via the controller interface 163. The high sensor 129, the medium sensor 127, and the low sensor 125 transmit information to the controller 161 regarding the position of the float 119, and the controller 161 activates the condensate pump 151 based on the information received. The controller 161 may also be in communication with the first chamber sensor and the second chamber sensor, and may receive information from the first chamber sensor and the second chamber sensor regarding the condensate levels in the first chamber 111 and the second chamber 117, respectively. In an embodiment, the controller 161 communicates with sensors and/or a thermostat or other control components via a wireless link. For example, and without limitation, the controller 161 communicates using a wireless computer network protocol or a proprietary protocol over a radio link. In one embodiment, a detachable wiring harness is used that does not require additional tools to attach. The detachable wiring harness may provide electricity to the condensate pump 151 and/or the controller 161. If the condensate pump 151 was later replaced, the wiring harness could be unplugged from the condensate pump 151 and/or the controller 161, and reinstalled into a new condensate pump. The wiring of the wiring harness could be keyed so that the wiring could not be installed incorrectly.

The reservoir 101 and the condensate pump 151 may be mounted in, for example and without limitation, ductwork 310, such as shown in FIG. 9. A mounting bracket 301 with an integrated elastomer may be provided to mount the condensate pump 151 and the reservoir 101 to a wall. The elastomer may allow the reservoir 101 and the condensate pump 151 to be isolated from other components of the air handling system, and may serve to dampen vibrational energy from the reservoir 101 and/or the condensate pump 151, and other components of the air handling system. The mounting bracket 301 may be positioned within a conduit 312 and be mounted to the conduit 312. A cover may be provided to cover the mounting bracket, the reservoir 101, and the condensate pump 151, and other components of the air handling system. For example, the coolant may flow from the heat exchanger and fan to the heat exchanger and pump in one or more flexible tubes that are positioned within the conduit 312 and which are covered by the cover. The cover may be releasably attached to the conduit 312 so that the cover may be removed without additional tools, and the reservoir 101, the condensate pump 151, or other components may be reached and/or serviced.

The condensate pump 151 may attach to the mounting bracket 301 without the use of additional tools. For example, the mounting bracket 301 may include one or more projections, and/or the condensate pump 151 may include one or more projections. The projections of the mounting bracket 301 and/or the condensate pump 151 may reversibly engage to attach the mounting bracket 301 to the condensate pump 151. In one embodiment, a part of the mounting bracket may slide into a corresponding slot on the condensate pump 151, or vice versa.

The reservoir 101 may also attach to the mounting bracket 301 without the use of additional tools. The reservoir 101 may also include one or more projections, and/or the mounting bracket 301 may include one or more projections to releasably attach the reservoir 101 to the mounting bracket 301. In one embodiment, a part of the mounting bracket 301 may slide into a corresponding slot on the reservoir 101, or vice versa. The illustrated slots of reservoir bracket 131 and pump bracket 157 permit reservoir 101 and pump 151 to be mounted to the retainer in a right-hand orientation (illustrated) and a left-hand orientation.

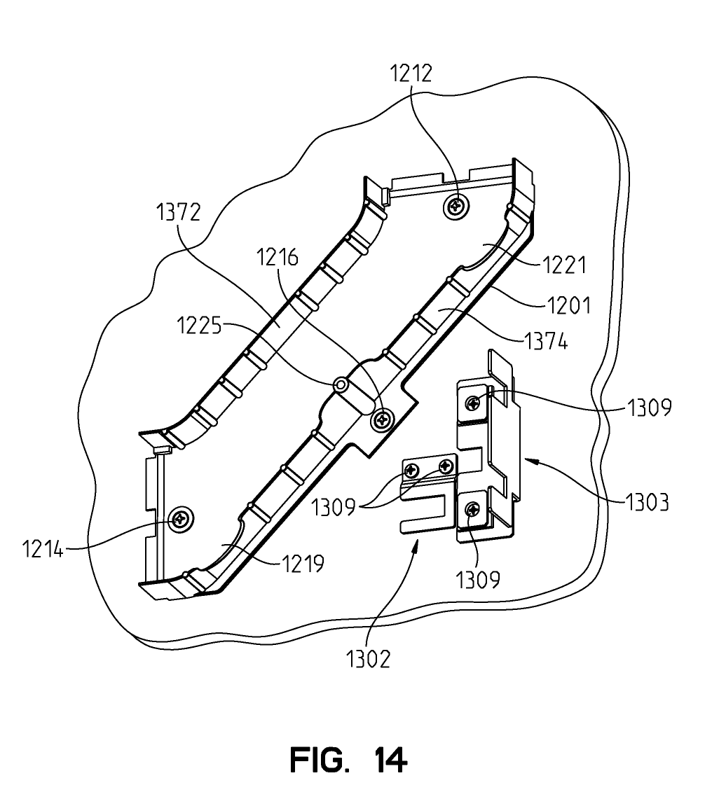

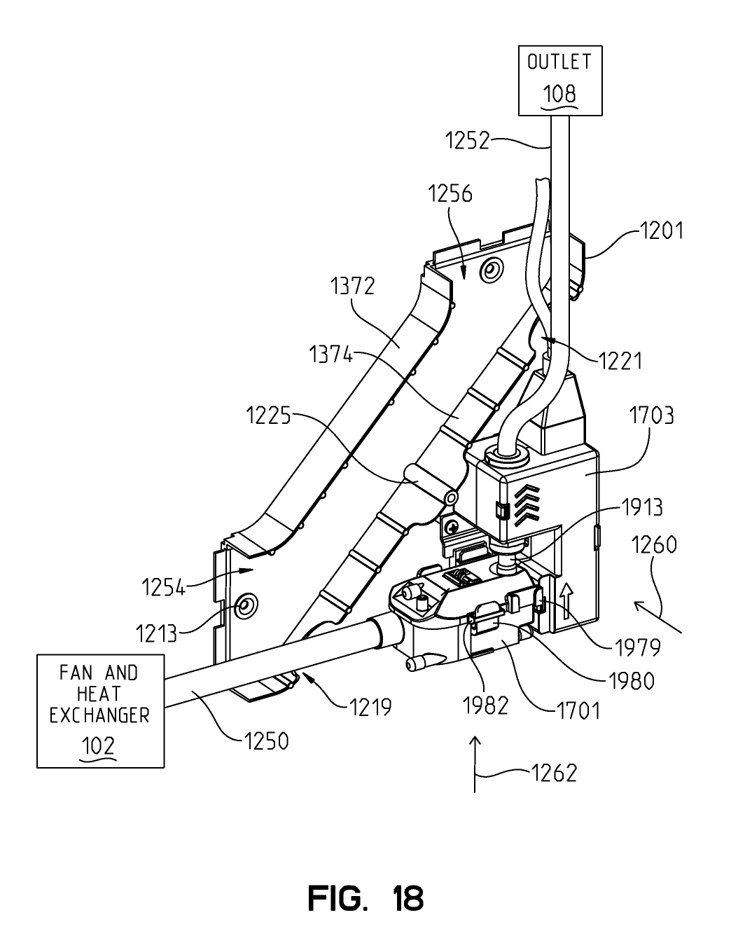

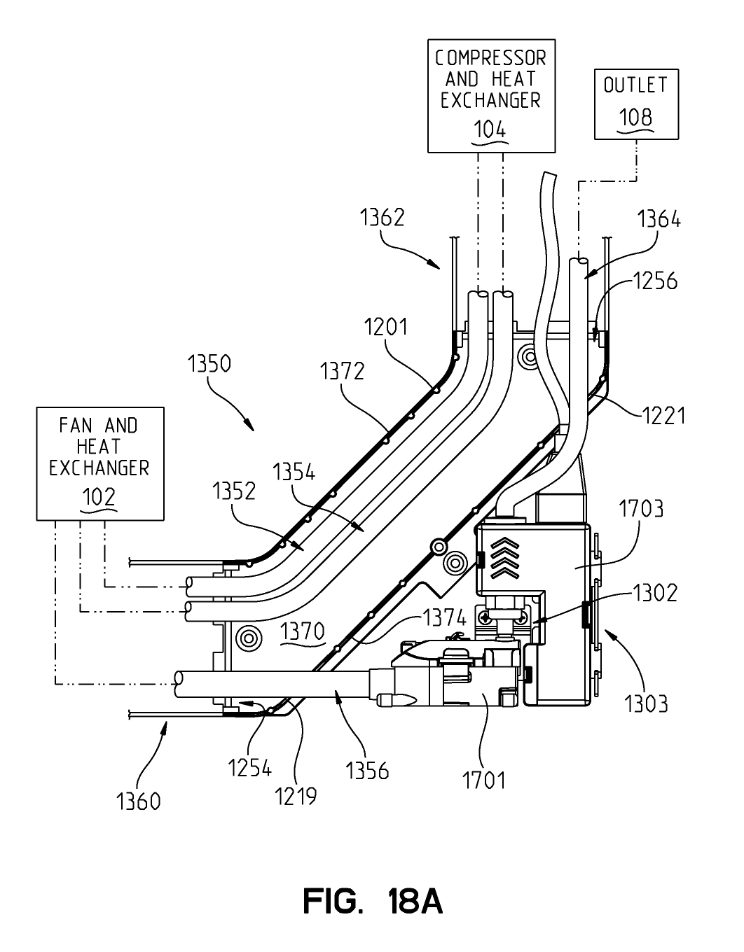

Referring to FIGS. 12-25, another embodiment is shown. Referring to FIG. 12, a conduit 1201 may be supplied to mount to a wall 1209 in either a right-hand or left-hand orientation. Referring to FIG. 18A, conduit 1201 is a part of the ductwork 1350 through which the coolant lines 1352, 1354 that travel between fan and heat exchanger 102 and compressor and heat exchanger 104 are guided. Further, a reservoir 1701 and a condensate pump 1703, in the illustrated embodiment, mount to a wall 1209 (see FIG. 18) independently of each other and independent of conduit 1201. The reservoir 1701 is mounted to wall 1209 through a reservoir bracket 1302 (see FIG. 14) and the condensate pump 1703 (see FIG. 14) is mounted to wall 1209 through a condensate pump bracket 1303.

A condensate line 1356 receives condensate from fan and heat exchanger 102 and communicates the same to reservoir 1701. Condensate line 1356 and coolant lines 1352, 1354 run from fan and heat exchanger unit 102 through a horizontal conduit 1360 and into conduit 1201 through open end 1254. Coolant lines 1352 and 1354 continue through conduit 1201 and exit through open end 1256 and enter a vertical conduit 1362. The coolant lines then continue on to compressor and heat exchanger unit 104. In contrast, condensate line 1356 exits conduit 1201 through opening 1219 and connects to reservoir 1701 outside of the conduit 1201. The condensate is stored in the reservoir 1701 and then pumped by condensate pump 1703 to a second condensate line 1364 which reenters conduit 1201 through opening 1221. The condensate line 1364 then continues through vertical conduit 1362 to outlet 108.

Conduit 1201 includes a base 1370, a first upstanding wall 1372, and a second upstanding wall 1374. Opening 1254 is provided between the first upstanding wall 1372 and the second upstanding wall 1374. Opening 1256 is provided between the first upstanding wall 1372 and the second upstanding wall 1374.

As shown in FIG. 18, the reservoir 1701 and condensate pump 1703 are mounted to wall 1209 outside of conduit 1201. Condensate fluid produced by fan and heat exchanger unit 102 travels through a fluid conduit 1250 to reservoir 1701. The condensate fluid is evacuated from reservoir 1701 by condensate pump 1703 through a fluid conduit 1913. The condensate fluid exits condensate pump 1703 and travels through a fluid conduit 1252 to outlet 108. As illustrated in FIG. 18, fluid conduit 1250 enters conduit 1201 through opening 1254 and exits conduit 1201 through opening 1219 to reach reservoir 1701 because reservoir 1701 is positioned outside of conduit 1201. In a similar manner, fluid conduit 1252 enters conduit 1201 through an opening 1221 in conduit 1201 and exits conduit 1201 through an opening 1256.

Referring to FIG. 12, the installation of conduit 1201, reservoir 1701, and condensate pump 1703 is described. The conduit 1201 includes a mounting guide 1203 with a plurality of holes. The plurality of holes provide mounting indications of the appropriate locations for reservoir bracket 1302 and condensate pump bracket 1303. As shown in FIG. 12 conduit and the attached mounting guide 1203 are positioned against a wall 1209 in a right-hand orientation. The conduit and attached mounting guide may also be positioned against the wall in a left-hand orientation, if the fan and heat exchanger unit is to the right.

When conduit 1201 is positioned against wall 1209 in a location wherein openings 1254 and 1256 are correctly positioned to align with additional ductwork pieces, conduit 1201 may be secured to wall 1209 through fasteners 1212, 1214, and 1216 (see FIG. 14) which are received in apertures 1211, 1213, and 1217 of conduit 1201 and are driven into the wall 1209. In one embodiment, an installer first marks wall 1209 to indicate the position of apertures 1211, 1213, and 1217 and installs wall anchors (not shown) in wall at the indicated positions. The fasteners 1212, 1214, and 1216 are then received in the openings of the wall anchors.

In a similar manner, an installer assembles reservoir bracket 1302 and condensate pump bracket 1303 to wall 1209. The plurality of holes in the mounting guide 1203 are divided into two groups 1205 and 1207 to allow holes to be drilled into the wall to support the reservoir bracket 1302 and the condensate pump bracket 1303 in either a left-hand orientation or right-hand orientation. Group 1207, indicated by “R” in FIG. 12 are used for a right-hand installation. Group 1205, indicated by “L” in FIG. 12 are used for a left-hand installation. In an embodiment, the groups 1205 and 1207 are marked with indicia on mounting guide 1203 to separately identify the groups to an installer during installation. The mounting guide 1203 may include a score mark or other weakened portion 1215 to allow the guide 1203 to be detached from the conduit.

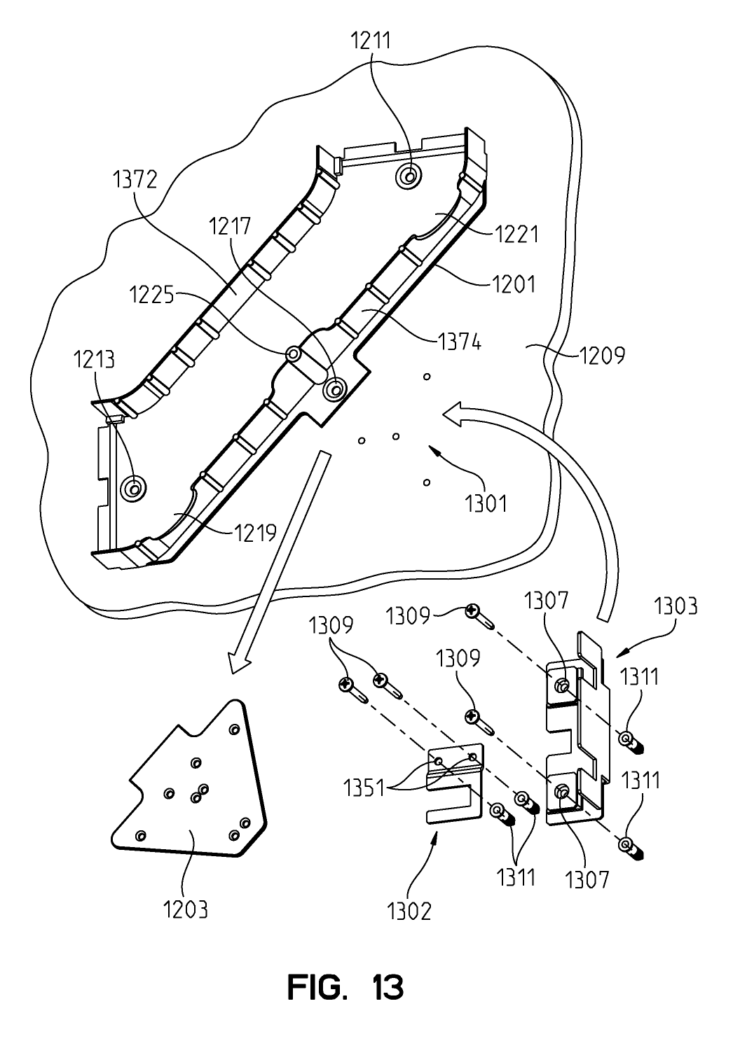

In FIG. 13, the guide 1203 has been detached along the weakened portion 1215 to remove the guide 1203 from the conduit 1201. Prior to the removal of the mounting guide, the installer has either marked indications on wall 1209 or drilled holes 1301 in wall 1209. If indications are marked, the installer will then drill holes 1301 and place wall anchors 1311 (see FIG. 13) in holes 1301, if needed. Either the indications or the holes 1301 left in the wall 1209 marked by the guide 1203 remain when guide 1203 is removed. Fasteners 1309 are received corresponding apertures in reservoir bracket 1302 and are received in the corresponding wall anchors mounted to wall 1209 which line up with holes 1307 in a reservoir bracket 1302. Similarly, additional fasteners 1309 are received corresponding apertures in condensate pump bracket 1303 and are received in the corresponding wall anchors 1311 mounted to wall 1209 which line up with holes 1307 in a condensate pump bracket 1302. FIG. 14 illustrates conduit 1201 secured to the wall 1209 using fasteners 1212, 1214, and 1216 the reservoir bracket 1302 is secured to the wall using fasteners 1309, and the condensate pump bracket 1303 is secured to the wall using fasteners 1309.

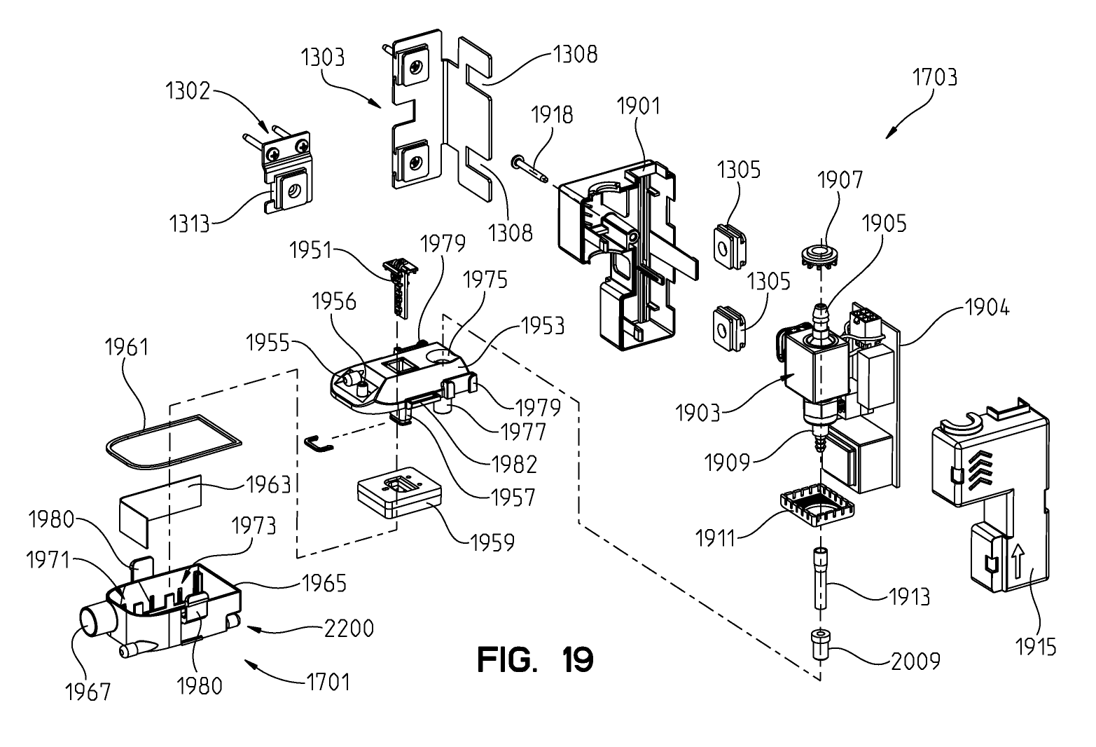

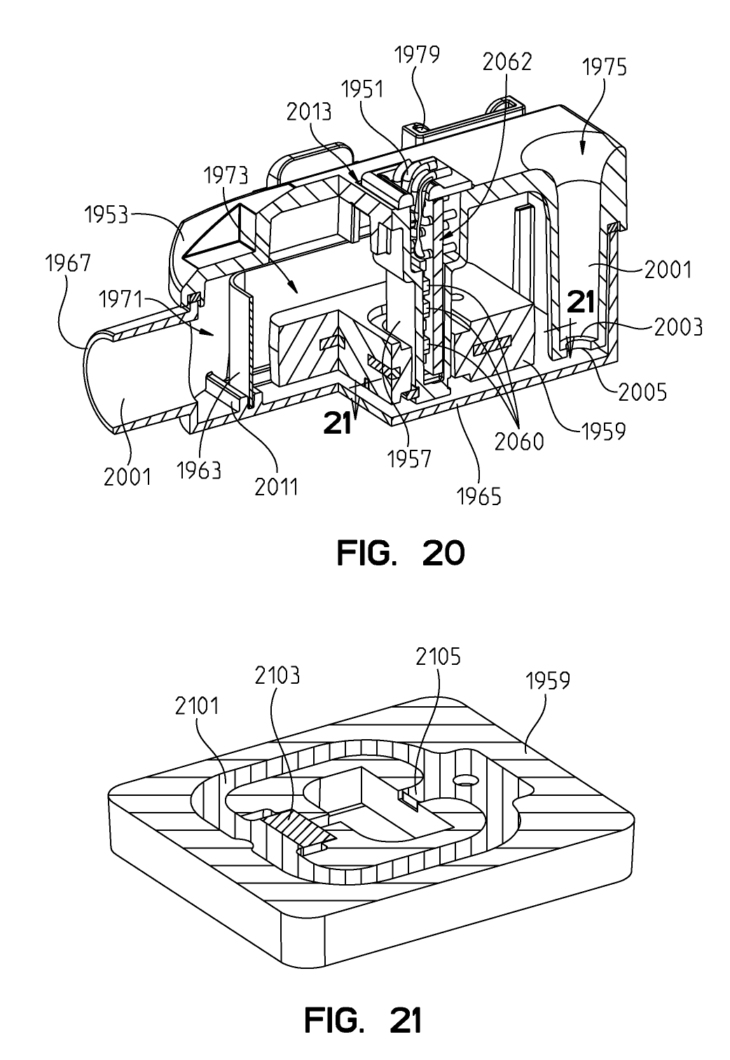

In FIG. 19, reservoir bracket 1302 carries an elastomeric grommet 1313 which couples reservoir 1701 to reservoir bracket 1302 as discussed herein. Condensate pump bracket 1303 carries a plurality of elastomeric grommets 1305 which are coupled to condensate pump 1703 and are slid into corresponding indentations 1308 of condensate pump bracket 1303 to couple condensate pump 1703 to condensate pump bracket 1303 as discussed herein. Referring to FIG. 18, condensate pump 1703 is coupled to condensate pump bracket 1303 by having grommets 1305 be received in indentations 1308 of condensate pump bracket 1303 and moving condensate pump 1703 in direction 1260. Fluid conduit 1913 is coupled to inlet port 1909 (see FIG. 19) of condensate pump 1703. Fluid conduit 1913 is received in void 2005 of reservoir 1701 as reservoir 1701 is moved in direction 1262. Fluid conduit 1913 does not seal against the side walls of void 2005 (see FIG. 20). As reservoir 1701 moves in direction 1262, a bracket 1979 is received in grommet 1313 and held by grommet 1313. When reservoir 1701 and condensate pump 1703 are mounted to wall 1209, reservoir 1701 is isolated from condensate pump 1703. This reduces the transfer of vibration from pump 1703 to reservoir 1701.

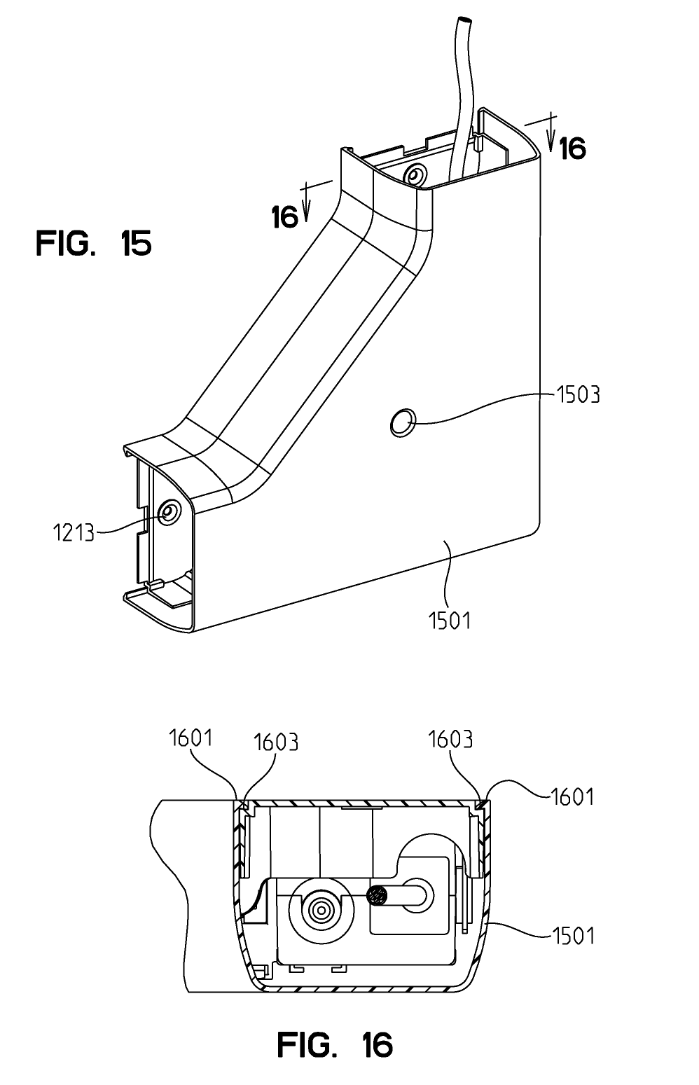

Referring to FIG. 15, a cover 1501 is placed over conduit 1201, reservoir 1701, and condensate pump 1703. Cover 1501 is coupled to conduit 1201 proximate to opening 1254 and proximate to opening 1256 as explained herein and through a fastener 1503 which is received in an aperture of cover 1501 and is threaded into a boss 1225 of conduit 1201. FIG. 16 is a top view of cover 1501 assembled to conduit 1201 taken along line 16-16. The cover 1501 is affixed to the conduit 1201. Fingers 1601, shown in FIG. 16, releasably attach to a corresponding lip 1603 on the conduit 1201 to secure the cover 1501 to the conduit 1201. A screw or other fastener 1503 may be inserted through the aperture to secure the cover 1501 to the conduit 1201.

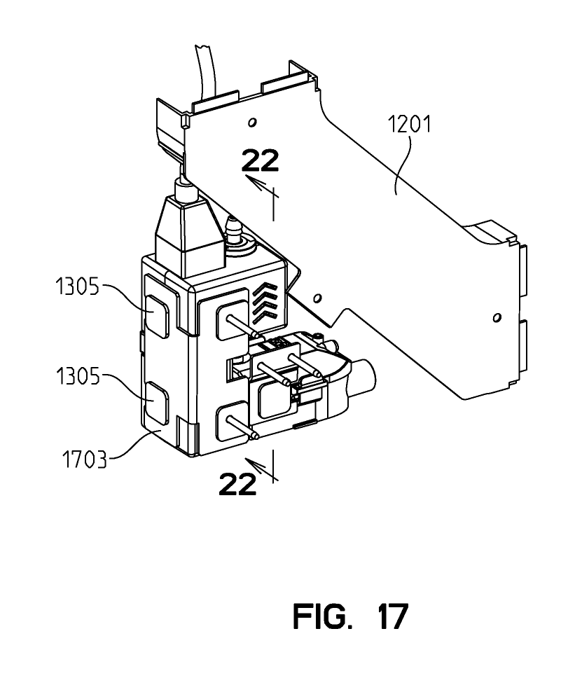

FIG. 17 is a rear perspective view of conduit 1201, reservoir 1701, and condensate pump 1703 according to an embodiment of the present disclosure. FIG. 18 is a front perspective view of conduit 1201, reservoir 1701, and condensate pump 1703 and pump according to an embodiment of the present disclosure. The reservoir 1701 and condensate pump 1703 are adjacent to each other in this embodiment, but separate. In other embodiments, the pump and the reservoir may be further spaced apart.

Referring to FIGS. 19-21, an exemplary embodiment of reservoir 1701 is shown. Reservoir 1701 includes a basin 1965 and a top structure 1953. Basin 1965 includes an inlet port 1967 for receiving the condensate into the basin 1965, and an outlet port 1975 through which the condensate may exit the basin 1965. Reservoir 1701 may include a single inlet port 1967 and a single outlet port 1975. In one embodiment, multiple inlet ports and/or outlet ports are provided.

The basin 1965 may be a single piece, or may be one or more parts that are fastened or fused together. In one embodiment, the basin 1965 is substantially optically transparent, so that the level of condensate and/or the overall operation of the reservoir 1701 may be monitored without disassembling the reservoir 1701. The basin 1965 includes an inlet port 1967 and a screen retaining structure 2011 (see FIG. 20). In another embodiment, the inlet port 1967 and the screen retaining structure 2011 may be attached to the basin 1965. The screen retaining structure 2011 holds a screen 1963 which divides the interior of the basin into a first chamber 1971 and a second chamber 1973. The first chamber being in fluid communication with the inlet port 1967. The second chamber 1973 being in fluid communication with the outlet port 1975.

The basin 1965 may also include one or more retainers 1980 (see FIG. 19) that releasably engage with or otherwise cooperate with one or more retainers 1982 (see FIG. 19) located on the top structure 1953. Exemplary retainers include clips, fasteners, snap features, and other suitable devices to hold or constrain the relative position of two components in at least one degree of freedom. In one embodiment, a seal 1961 rests between the basin 1965 and the top structure 1953. In another embodiment, the basin 1965 may also have a lip or groove that may engage with a similar lip or groove on the top structure 1953, in order to form a seal so that condensate or other material may not escape from the interface between the basin 1965 and the top structure 1953, when the basin 1965 and the top structure 1953 are engaged.

The inlet port 1967 may be the same material as the basin 1965. The inlet port 1967 may be a part of the basin 1965 or assembled thereto. In another embodiment, the inlet port 1967 may be a different material as the basin 1965, or may be attached to the basin 1965. The inlet port 1967 is in fluid communication with the first chamber 111 of basin 1965. The inlet port 1967 releasably engages with a rigid or flexible connector to receive condensate from an air handling system. For example, and without limitation, the inlet port 1967 may connect to a flexible tube, so that condensate and/or particulate matter flows through the flexible tube, through the inlet port 1967, and into the first chamber 111 of the reservoir 1701.

The top structure 1953 may be the same material as the basin 1965, or may be a different material. For example, and without limitation, the basin 1965 is substantially optically transparent. The top structure 1953 includes an outlet port 1975, brackets 1979, and a float support 1957. The outlet port 1975, the brackets 1979, and the float support 1957 are integrated into the top structure 1953 in an embodiment. In another embodiment, the outlet port 1975, the brackets 1979, and the float support 1957 may be separate from the top structure 1953, and attached to the top structure 1953.

The outlet port 1975 includes a wall 2001, a floor 2003, and a void 2005 in the floor 2003 which is in fluid communication with the second chamber 1973 of the basin 1965. A rigid or flexible connector extends into the interior of the outlet port 1975, to allow condensate to be pulled from the second chamber 1973 to the condensate pump 1703, but does not form a seal with the outlet port 1975 in the illustrated embodiment. For example, and without limitation, the outlet port 1975 may receive a flexible tube, such as fluid conduit 1913 (see FIG. 19), so that condensate and/or particulate matter flows from the second chamber 1973 of the reservoir 1701, through the outlet port void 2005, through the flexible tube 1913, and to the condensate pump 1703. In one example, a lower end of fluid conduit 1913 is positioned proximate floor 2003 of outlet port 1975 and the condensate level in second chamber 1973 is above the lower end of the fluid conduit 1913. Since fluid conduit 1913 does not form a seal with wall 2001 of outlet port 1975, the condensate may travel up between wall 2001 and an exterior of fluid conduit 1913 as the condensate level in second chamber 1973 rises.

In an embodiment, an elastomeric seal 2009 may be placed over the outlet port 1975 when an alternative outlet port, such as port 2200 (see FIG. 19), is to be used to evacuate condensate from second chamber 1973. Reservoir 1701 further includes two vent ports 1955 and 1956. Vent port 1955 is horizontally oriented and vent port 1956 is vertically oriented.

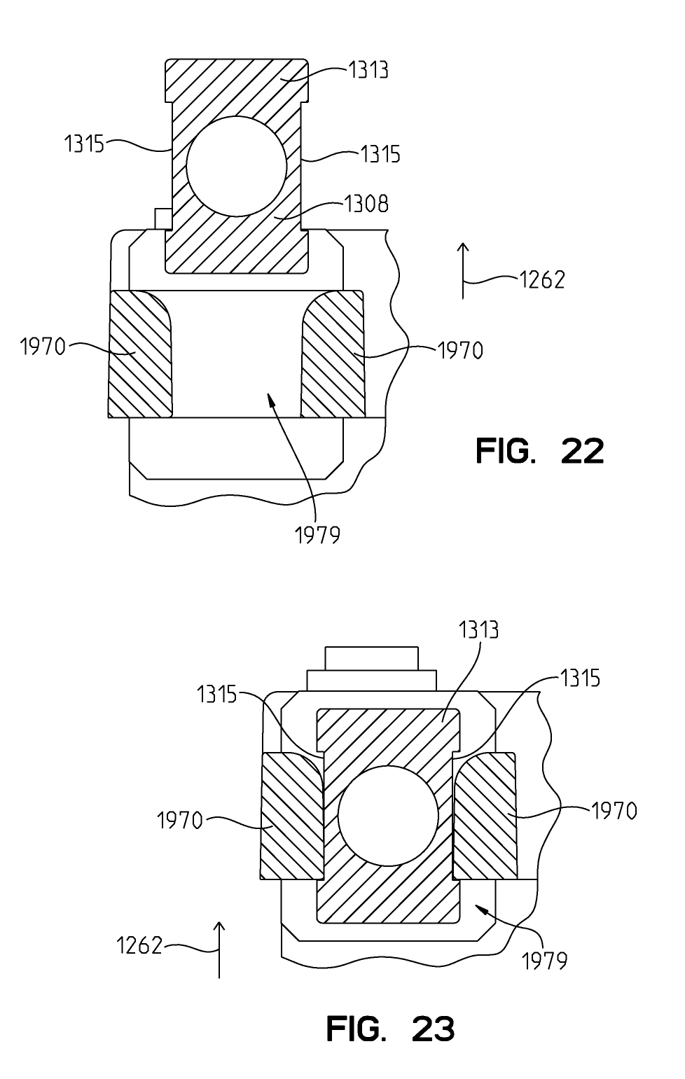

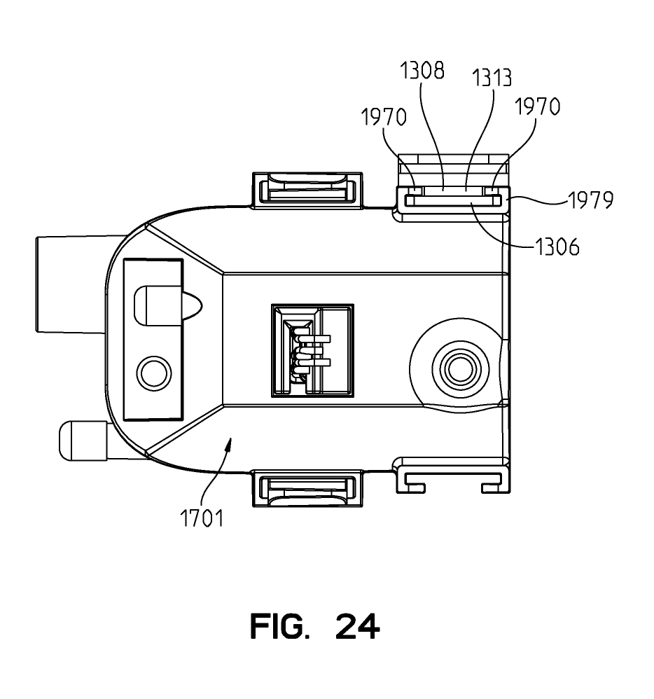

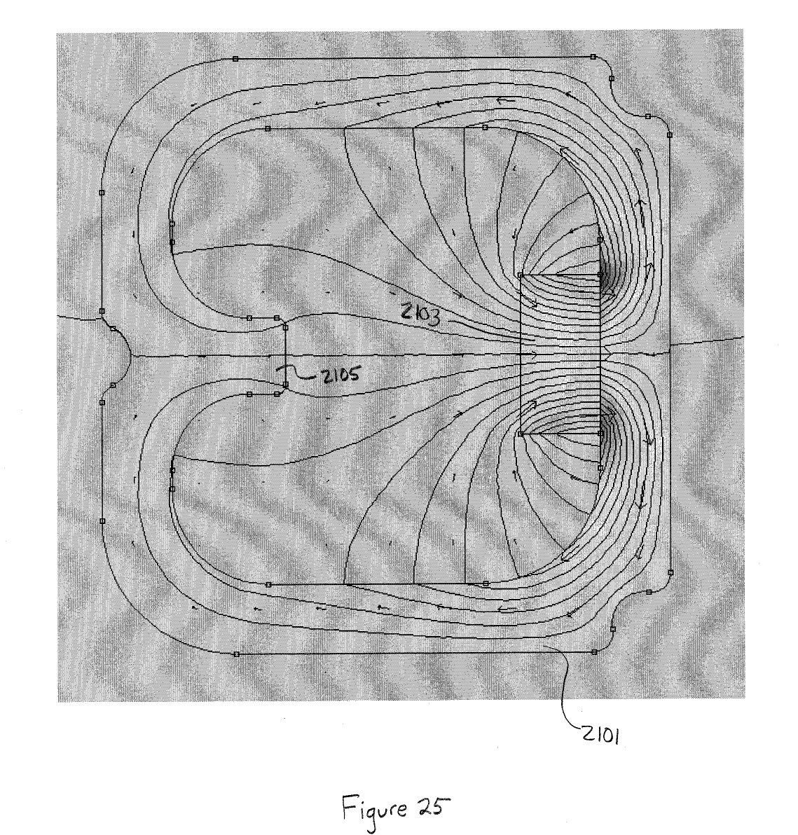

Top structure 1953 further includes brackets 1979 which are, in the illustrated embodiment, positioned on two sides of the top structure 1953. The brackets 1979 are shown with respect to FIG. 19, and are also shown in FIGS. 22 and 23. Depending on the orientation of reservoir 1701, one of brackets 1979 secures reservoir 1701 to grommet 131 of reservoir bracket 1302. The brackets 1979 may include a lip or other projection that may releasably engage with one or more grommets 1313 to releasably secure the reservoir 1701 to the bracket 1303. In the illustrated embodiment, the bracket 1979 includes spaced part tabs 1970 which have a separation that is narrower than a width of grommet 1313. The grommet 1313 does include a pair of engagement grooves 1315 to locate reservoir 1701. Referring to FIGS. 22-24, reservoir 1701 is assembled to reservoir bracket 1302 by moving reservoir 1701 and hence bracket 1979 in direction 1262 relative to grommet 1313. Referring to FIG. 24, grommet 1313 includes a front portion 1306 which is captured by bracket 1979 and a middle portion 1308 which engages tabs 1970 of bracket 1979 to hold a vertical position of reservoir 1701 relative to grommet 1313. Referring to FIG. 22, a lower section of the middle portion 1308 of grommet 1313 is wider than the separation between tabs 1970 of bracket 1979. In contrast, a middle section of the middle portion 1308 of grommet 1313 includes engagement surfaces which generally have the same separation as tabs 1970 of bracket 1979. As bracket 1979 is moved in direction 1262, the lower section of middle portion 1308 of grommet 1313 deforms to allow tabs 1970 to advance towards the middle section of middle portion 1308 of grommet 1313. When tabs 1970 are generally aligned with the middle section of middle portion 1308 of grommet 1313 the lower section of the middle portion 1308 of grommet 1313 may return substantially to its original shape. The lower section of the middle portion 1308 of grommet 1313 thereafter retains tabs 1970 and holds reservoir 1701 relative to reservoir bracket 1302. Brackets 1979 are positioned on either side of the top structure 1953 to allow the reservoir 1701 to be mounted to the bracket 1303 in either a left-hand or a right-hand orientation.

The float support 1957 extends from the surface of the top structure 1953 into the basin 1965. The float support 1957 also includes a void 2013 extending from the upper surface of the top structure 1953. One or more sensors 2060 are supported by a circuit board 2062 which is received in the void 2013. The sensors 2060 interact with a magnet 2103 attached to the float 1959.

When the top structure 1953 is releasably engaged with the basin 1965, the float support 1957 extends into the basin 1965, and the float 1959 surrounds the float support 1957 so that the movement of the float 1959 is substantially constrained except for movement towards the top structure 1953 and away from the top structure 1953. The groove or lip of the basin 1965 and the groove or lip of the top structure 1953 may engage, so as to form a seal to substantially contain the condensate within the basin 1965 from escaping from the interface between the top structure 1953 and the basin 1965.

The float 1959 may be a closed cell foam material, for example Styrofoam, or may be an enclosed plastic material allowing the float 1959 to rise and fall along the float support 1957 axis in response to the level of condensate liquid in the second chamber 1973. If no condensate liquid is in the second chamber 1973, for example, the float 1959 may rest on the lower inner surface of the basin 1965. If the second chamber 1973 is partially full of condensate liquid, the float 1959 may rest at a location spaced apart from the lower inner surface of the basin 1965. The float 1959 additionally has one or more magnets 2103, illustratively one, deposited on the surface of the float 1959 or embedded within the float 1959. The magnet 2103 interacts with the one or more sensors in the float support 1957 to indicate the amount of condensate liquid in the second chamber 1973. In one embodiment, the float 1959 may be symmetrical, and the magnet 2103 is positioned to one side of the float support 1957.

Referring to FIG. 21, the magnet 2103 is embedded within the float 1959. A ring structure 2101 is also embedded in the float 1959. The ring structure 2101 is a metal that interacts with the magnetic field of the magnet 2103, and directs the magnetic field to substantially increase the interaction of the magnetic field with one or more sensors in the float support 1957 in a horizontal plane generally aligned with the ring structure and to substantially decrease the interaction of the magnetic field with the one or more sensors in the float support at other positions. In one embodiment, the ring structure 2101 focuses the magnetic field so that it interacts with an adjacent sensor, but not with non-adjacent sensors, while the float 1959 moves within the float support 1957. In one embodiment, the ring structure 2101 also minimizes the interaction of the magnetic field with other structures. A metallic projection 2105 of ring structure 2101 is exposed to the float support 1957 also focuses the magnetic field. FIG. 25 is an exemplary simulation of exemplary magnetic field lines produced by magnet 2103 in the exemplary float structure. The ring structure 2101 interacts with the magnetic field to guide the field around in a circle and to generally keep the field in the middle between magnet 2103 and projection 2105 generally uniform.

As mentioned herein, screen retaining structure 2011 captures or otherwise holds a screen 1963 which divides the basin 1965 into a first chamber 1971 and a second chamber 1973, and allows condensate to pass from the first chamber 1971 to the second chamber 1973, but may stop debris and other particulate matter from passing from the first chamber 1971 to the second chamber 1973. The screen 1963 may be a rigid or flexible material containing a plurality of openings through the screen 1963. The openings may be of any size, shape, and number to selectively allow material to pass from the first chamber 1971 to the second chamber 1973. The openings may be sized to allow condensate and material of a certain size to pass from the first chamber 1971 to the second chamber 1973, or may be sized to allow condensate, while excluding substantially all other matter from passing from the first chamber 1971 to the second chamber 1973. The screen 1963 may be releasably engaged by the screen retaining structure 2011 of the basin 1965, so that the base and sides of the screen 1963 are held in place by the screen retaining structure 2011.

The screen 1963 may be L-shaped. In one embodiment, and as shown in FIG. 20, the screen 1963 extends toward the inlet opening. In another embodiment, the screen 1963 extends away from the inlet opening. In yet another embodiment, the screen 1963 is substantially flat, and extends across the basin 1965. The screen 1963 may be removable, so that the top structure 1953 of the basin 1965 may be removed and the screen 1963 may be removed from the basin 1965. The screen 1963 may be removable for cleaning or replacement. In one embodiment, screen 1963 is positioned on an opposite side of float 1959 such that float 1959 is in the first chamber 1973 and responds to the level of condensate liquid in the first chamber 1973.

Referring to FIG. 19, the condensate pump apparatus 1703 includes a pump 1903, a control board 1904, and a first and second housing structure 1901 and 1915. The first and second structures 1901 and 1915 attach together using one or more fingers and retaining structures or one or more fasteners, such as fastener 1918. Grommets 1305 fit between the first and second structures 1901 and 1915, and are retained in place by one or more projections of the first and second structures 1901 and 1915 resting within one or more grooves of the grommets 1305. The grommets 1305 may be an elastomeric material, and may dampen vibration transfer between the condensate pump 1703 and the bracket 1303. The first and second structures 1901 and 1915 may be the same material in a one-piece construction, or one or more of the elements may be separate and attached together. An upper elastomeric member 1907 and a lower elastomeric member 1911 may be seated between the first and second structures 1901 and 1915, and may dampen vibration transfer between the condensate pump 1703 and the bracket 1303, or between the condensate pump 1703 and the wall. During assembly, the pump 1903 is placed within the first and second structures 1901 and 1915, and the upper elastomeric member 1907 and the lower elastomeric member 1911, along with the grommets 1305, are seated within one or more grooves or one or more projections in the first and second structures 1901 and 1915. Projections on the first and/or second structures 1901 and 1915 releasably secure the first and second structures 1901 and 1915 to each other. Grommets 1305 extend outside of the first and second structures 1901 and 1915 to releasably engage indentations 1308 on the bracket 1303.

The pump 1903 includes an inlet port 1909 which is coupled to fluid conduit 1913. Pump 1903 pulls condensate from the second chamber 1973 of the reservoir 1701 through the flexible tube 1913 connecting the reservoir 1701 to the condensate pump 1703. The pump 1903 pushes condensate through and out of the outlet port 1905. The pump 1903 may be similar to the pump described in U.S. Patent Publication No. 2009/0129939, application Ser. No. 11/985,503, entitled “Apparatus for Thermal Dissipation and Retention of Float,” and filed Nov. 15, 2007, the disclosure of which is herein incorporated by reference in its entirety. The condensate pump 1903 may, for example, include the ability to recirculate condensate past the pump to help cool the pump 1903.

One or more of the components may be similar to the components or methods described in “Sediment Trap System and Method,” U.S. Provisional Patent Application 61/324,554, filed Apr. 15, 2010, Attorney Docket Number FEC0150, the disclosure of which is expressly incorporated by reference herein.

While this disclosure has been described as having exemplary designs, the present disclosure can be further modified within the spirit and scope of this disclosure. This application is therefore intended to cover any variations, uses or adaptations of the disclosure using its general principles. Further, this application is intended to cover such departures from the present disclosure as come within known or customary practice in the art to which this disclosure pertains and which fall within the limits of the appended claims.

We claim:

1. An apparatus for handling a fluid, the apparatus comprising:
a reservoir having a basin which receives the fluid and at least a first port through which the fluid is evacuated;
a pump housing including a fluid pump;
a fluid conduit in fluid communication with the fluid in the reservoir through the first port of the reservoir and in fluid communication with the fluid pump;
at least one sensor which provides an indication of a height of the fluid in the reservoir;
a controller which activates the fluid pump based on the height of the fluid in the reservoir;
a conduit with a first aperture and a second aperture therethrough, wherein the reservoir and the pump housing are external to the conduit, and the fluid travels from an interior of the conduit, through the first aperture to an exterior of the conduit, into the reservoir, through the fluid conduit, and through the second aperture back into the interior of the conduit.

2. The apparatus of claim 1, wherein the conduit is supported by a support structure and the conduit further comprises a removable template for the placement of a first bracket to secure the reservoir to the support structure and a second bracket to secure the pump housing to the support structure.

3. The apparatus of claim 2, wherein the removable template provides a first mounting scenario for securing the reservoir and the pump housing to the support structure in a left-hand orientation and a second mounting scenario for securing the reservoir and the pump housing to the support structure in a right-hand orientation.

4. The apparatus of claim 1, further comprising a float including at least one magnet, the reservoir including a float support which carries the at least one sensor, the at least one sensor providing an indication of a position of the float in the reservoir, the float including a metallic ring structure which directs the magnetic field of the at least one magnet.

5. The apparatus of claim 1, further comprising a screen, the screen limiting debris from entering the first port of the reservoir.

6. The apparatus of claim 1, wherein the reservoir further includes a plurality of vent ports in fluid communication with the basin of the reservoir, the plurality of vent ports being oriented in a plurality of directions.

7. The apparatus of claim 2, wherein the reservoir and the pump housing are mounted independently to the support structure.

8. An apparatus for handling a fluid, the apparatus comprising:
a reservoir having a basin which receives the fluid and at least a first port through which the fluid is evacuated, the reservoir including at least one reservoir bracket to releasably attach the reservoir to a wall;
a pump housing including a fluid pump;
a fluid conduit in fluid communication with the fluid in the reservoir through the first port of the reservoir and in fluid communication with the fluid pump;
at least one sensor which provides an indication of a height of the fluid in the reservoir;
a controller which activates the fluid pump based on the height of the fluid in the reservoir;
a wall bracket to releasably attach the reservoir to the wall, the wall bracket including a grommet with an engagement surface, wherein the reservoir bracket and the grommet cooperate to releasably secure the reservoir and to maintain a position of the reservoir relative to the wall.

9. The apparatus of claim 8, wherein the wall bracket is configured to permit the reservoir to be mounted to the wall in a left-hand or right-hand orientation.

10. The apparatus of claim 8, wherein the reservoir also includes at least one sensor and a float including at least one magnet, the reservoir including a float support which carries the at least one sensor, the at least one sensor providing an indication of a position of the float in the reservoir, the float including a metallic ring structure which directs the magnetic field of the at least one magnet.

11. The apparatus of claim 8, wherein the grommet and the reservoir bracket cooperate to hold the reservoir in a vertical direction.

12. The apparatus of claim 11, wherein the grommet is made of a material that substantially dampens vibrational energy.

13. A method of installing a condensate removal system for an air handling system, the method comprising the steps of:
coupling a conduit to a wall, the conduit carrying the coolant lines for the air handling system;
coupling a condensate reservoir to the wall independent of the conduit, the condensate reservoir being external to the conduit;
coupling a condensate pump to the wall independent of the condensate reservoir and independent of the conduit, the condensate pump being external to the conduit.

14. The method of claim 13, wherein the condensate reservoir and the condensate pump are positioned to a first side of the conduit when coupled to the wall.

15. The method of claim 13, wherein the conduit includes a first aperture and a second aperture therethrough, and wherein fluid travels from an interior of the conduit, through the first aperture to an exterior of the conduit, into the reservoir, through a fluid conduit, and through the second aperture back into the interior of the conduit.

16. The method of claim 14, wherein the conduit is supported by a support structure and the conduit further comprises a removable template for the placement of a first bracket to secure the reservoir to the support structure and a second bracket to secure the pump housing to the support structure.

17. The method of claim 16, wherein the removable template provides a first mounting scenario for securing the reservoir and the pump housing to the support structure in a left-hand orientation and a second mounting scenario for securing the reservoir and the pump housing to the support structure in a right-hand orientation.

18. A conduit for an air handling system having cooling lines and a condensate line, the conduit comprising:
a base;
a first upstanding wall;
a second upstanding wall;
a first opening through which the cooling lines and the condensate line pass, the first opening being between the first upstanding wall and the second upstanding wall;
a second opening through which the cooling lines and the condensate line pass, the second opening being between the first upstanding wall and the second upstanding wall and being spaced apart from the first opening; and
a detachable mounting template coupled to one of the base, the first upstanding wall, and the second upstanding wall, the mounting template providing mount locations for at least one of a reservoir and a pump, the mount locations being external to a space between the first upstanding wall and the second upstanding wall.

19. The conduit of claim 18, wherein the detachable mounting template provides a first mounting scenario for securing the reservoir and the pump to a support structure in a left-hand orientation and a second mounting scenario for securing the reservoir and the pump to the support structure in a right-hand orientation.

20. The conduit of claim 18, wherein the reservoir and the pump are attached to a wall with at least one mounting bracket, the at least one mounting bracket using the mount locations from the mounting template.

21. An apparatus for handling a fluid, the apparatus comprising:
a reservoir having a basin which receives the fluid and at least a first port through which the fluid is evacuated;
a pump housing including a fluid pump;
a fluid conduit in fluid communication with the fluid in the reservoir through the first port of the reservoir and in fluid communication with the fluid pump;
at least one sensor which provides an indication of a height of the fluid in the reservoir;
a controller which activates the fluid pump based on the height of the fluid in the reservoir;
a float including at least one magnet, the reservoir including a float support which carries the at least one sensor, the at least one sensor providing an indication of a position of the float in the reservoir, the float including a metallic ring structure which directs the magnetic field of the at least one magnet.
